(19) United States
(12) Patent Application Publication
(10) Pub. No.: US 2025/0274357 A1
(43) Pub. Date: Aug. 28, 2025

(54) PROVIDING CLOUD MATURITY SCORES FOR IMPROVING CLOUD COMPUTING HEALTH

(71) Applicant: CDW LLC, Vernon Hills, IL (US)

(72) Inventor: Christopher Pyle, Delray Beach, FL (US)

(21) Appl. No.: 19/197,968

(22) Filed: May 2, 2025

Related U.S. Application Data
(63) Continuation of application No. 18/215,682, filed on Jun. 28, 2023, now Pat. No. 12,316,510.

(51) Int. Cl. H04L 41/50; H04L 41/16

(52) U.S. Cl. CPC H04L 41/50; H04L 41/16

(57) ABSTRACT

A computing system includes a processor and a memory having stored thereon computer-executable instructions that, when executed, cause the computing system to receive generated cloud maturity scores related to one or more hyperscaler instances; identify, based on the one or more cloud maturity scores, one or more optimization recommendations for adjusting cloud configurations; implement the one or more optimization recommendations to adjust the cloud configurations of the one or more hyperscaler instances; and generate one or more updated cloud maturity scores. A method includes receiving one or more generated cloud maturity scores related to one or more hyperscaler instances; identifying, based on the one or more cloud maturity scores, one or more optimization recommendations for adjusting cloud configurations of one or more hyperscaler instances; implementing the one or more optimization recommendations to adjust the cloud configurations; and generating one or more updated cloud maturity scores.

This application is a continuation of U.S. application Ser. No. 18/215,682, filed Jun. 28, 2023, and entitled “Providing Cloud Maturity Scores for Improving Cloud Computing Health”, which is hereby incorporated by reference herein in its entirety.

### TECHNICAL FIELD

The present disclosure is directed to improvements related to providing cloud maturity scores for improving cloud computing health. More particularly, the present disclosure is directed to using machine learning (ML) and artificial intelligence (AI)-based techniques to generate respective values for cloud computing criteria, and for calculating cloud maturity scores based on the respective values.

### BACKGROUND

A multi-brand provider of information technology solutions to international customers in the business, government, education and healthcare industries may provide a broad array of products and services ranging from hardware and software to integrated information technology solutions such as security, cloud computing, hybrid infrastructure and digital experience.

Understanding cloud maturity in a multi-cloud environment is challenging for several reasons. First, in a multi-cloud environment, organizations typically use multiple cloud service providers (e.g., hyperscalers), each with distinctive features and functionality. These differences make it difficult to assess the overall status of the respective cloud environments, as each one may have distinctive features and functionality in specific areas. Second, integrating multiple cloud environments is complex, especially when it comes to interoperability and data exchange between different cloud services. It can be challenging to assess the maturity level of a multi-cloud environment that has multiple linked systems with varying respective levels of maturity.

Evolving technology presents another challenge. The continuously evolving features and capabilities being introduced regularly make assessing the maturity level of a multi-cloud environment difficult, as the environment's underlying structure, parameters, and functionality can change rapidly. In recent years, it has become particularly difficult for cloud computing clients to manage all of the disparate cloud and service management tools across various cloud providers, which each present different consoles, reports, invoices, recommendations, chargebacks, onboarding and offboarding.

Currently, information technology (IT)/cloud computing administrators have an average of 30 web tabs open to manage their 80+ cloud applications and multi-cloud providers. They are using “swivel chair integration” to get their job done, using these different applications/portals to get their reporting.

Further, cloud administrators at many companies are losing productivity while developing one-off shell scripts, sometimes in esoteric reporting languages, to attempt to determine their overall cloud spend and providing the necessary visibility into future budgeting and forecasting. Finance and accounting units need the ability to provide visibility, budgeting, and cloud cost allocation by line of business application or business unit. However, these groups are resorting to manually navigating and reconciling numerous and complex cloud and software invoicing, which does not provide chargeback/showback capabilities-resulting in numerous unproductive hours and employee dissatisfaction. There is also the challenge of being “surprised” by their cloud bill due to unplanned and unwanted consumption.

All of this leads to a situation in which a company using multiple cloud platforms lacks objective criteria to understand and reason about their cloud footprint in terms of cost, resource optimization, security, performance, etc. Further, the company lacks ways to compare such metrics against those of other companies in general, let alone companies in the same peer group. This leads to great uncertainty and opacity regarding allocation of resources and strategic planning. For example, customer challenges include inability to measure progress in the financial operations of the cloud, inability to establish a baseline of where the company's cloud infrastructure, and inability to compare to others.

Accordingly, there is an opportunity for platforms and technologies for generating cloud maturity scores to improve cloud computing health, to enable users (e.g., cloud administrators, managers, etc.) to effectively track cloud infrastructure progress.

### BRIEF SUMMARY

In one aspect, a computer-implemented method for optimizing cloud computing configurations based on cloud maturity scores includes: (i) receiving generated cloud maturity scores related to one or more hyperscaler instances; (ii) identifying, based on the one or more cloud maturity scores, one or more optimization recommendations for adjusting cloud configurations of one or more hyperscaler instances; (iii) implementing the one or more optimization recommendations to adjust the cloud configurations; and (iv) generating one or more updated cloud maturity scores.

In another aspect, a computing system for optimizing cloud computing configurations includes (a) one or more processors; and (b) one or more memories having stored thereon computer-executable instructions that, when executed by the one or more processors, cause the computing system to: (i) receive generated cloud maturity scores related to one or more hyperscaler instances; (ii) identify, based on the one or more cloud maturity scores, one or more optimization recommendations for adjusting cloud configurations of one or more hyperscaler instances; (iii) implement the one or more optimization recommendations to adjust the cloud configurations; and (iv) generate one or more updated cloud maturity scores.

### BRIEF DESCRIPTION OF THE FIGURES

The figures described below depict various aspects of the system and methods disclosed therein. It should be understood that each figure depicts one aspect of a particular aspect of the disclosed system and methods, and that each of the figures is intended to accord with a possible aspect thereof. Further, wherever possible, the following description refers to the reference numerals included in the following figures, in which features depicted in multiple figures are designated with consistent reference numerals.

FIG. 1A depicts an exemplary computing environment for providing cloud maturity scores for improving cloud computing health, according to some aspects.

FIG. 1B depicts an exemplary computing environment for providing cloud maturity scores for improving cloud computing health to end users, according to some aspects.

FIG. 2 depicts exemplary cloud computing environments accessible by the computing environment of FIG. 1A and the computing environment of FIG. 1B, according to some aspects.

FIG. 3 depicts a block diagram of functionality provided by the exemplary cloud computing environment of FIG. 1A and/or FIG. 1B, according to some aspects.

FIG. 4A depicts a cloud management platform including a cloud environment maturity graphical user interface including exemplary numerical and categorical cloud maturity scores, according to some aspects.

FIG. 4B depicts a cloud management platform including a cloud environment maturity graphical user interface including exemplary recommendations for improving cloud maturity scores, according to some aspects.

FIG. 5A depicts cloud computing environment best practice rules, according to some aspects.

FIG. 5B depicts cloud computing environment best practice rules, according to some aspects.

FIG. 5C depicts cloud computing environment best practice rules, according to some aspects.

FIG. 5D depicts cloud computing environment best practice rules, according to some aspects.

FIG. 5E depicts cloud computing environment best practice rules, according to some aspects.

FIG. 5F depicts cloud computing environment best practice rules, according to some aspects.

FIG. 5G depicts cloud computing environment best practice rules, according to some aspects.

FIG. 5H depicts cloud computing environment best practice rules, according to some aspects.

FIG. 5I depicts cloud computing environment best practice rules, according to some aspects.

FIG. 5J depicts cloud computing environment best practice rules, according to some aspects.

FIG. 5K depicts cloud computing environment best practice rules, according to some aspects.

FIG. 5L depicts cloud computing environment best practice rules, according to some aspects.

FIG. 5M depicts cloud computing environment best practice rules, according to some aspects.

FIG. 5N depicts cloud computing environment best practice rules, according to some aspects.

FIG. 5O depicts exemplary cloud computing rules including the best practices of FIGS. 5A-5N paired with respective weights, according to some aspects.

FIG. 6A depicts graphical user interfaces for accessing cloud computing access control resources, according to some aspects.

FIG. 6B depicts graphical user interfaces for accessing cloud computing access control resources, according to some aspects.

FIG. 6C depicts graphical user interfaces for accessing cloud computing access control resources, according to some aspects.

FIG. 7A depicts graphical user interfaces for accessing cloud computing subscription resources, according to some aspects.

FIG. 7B depicts graphical user interfaces for accessing cloud computing cost management exports, according to some aspects.

FIG. 7C depicts graphical user interfaces for accessing cloud shells, according to some aspects.

FIG. 7D depicts graphical user interfaces for accessing a cloud shell terminal, according to some aspects.

FIG. 7E depicts graphical user interfaces for uploading/downloading files (e.g., scripts) to the cloud shell terminal, according to some aspects.

FIG. 7F depicts graphical user interfaces for accessing and deploying Identity Access Management (IAM) resources, according to some aspects.

FIG. 7G depicts graphical user interfaces for confirming access to IAM resources, according to some aspects.

FIG. 8 depicts an exemplary computer-implemented method for providing cloud maturity scores for improving cloud computing health, according to some aspects.

FIG. 9A depicts an exemplary graphical user interface for displaying a multicloud management spending statistics and recommendations report, according to some aspects.

FIG. 9B depicts an exemplary graphical user interface for displaying a multicloud management potential spending savings/recommendations by category report, according to some aspects.

FIG. 9C depicts an exemplary graphical user interface for displaying a multicloud management spending statistics/virtual machine (VM) rightsizing recommendation report, according to some aspects.

FIG. 9D depicts an exemplary graphical user interface for displaying a multicloud management maturity score report, according to some aspects.

FIG. 9E depicts an exemplary graphical user interface for displaying a multicloud management anomaly report, according to some aspects.

The figures depict preferred aspects for purposes of illustration only. One skilled in the art will readily recognize from the following discussion that alternative aspects of the systems and methods illustrated herein may be employed without departing from the principles of the invention described herein.

### DETAILED DESCRIPTION

### Overview

The present aspects may relate to, inter alia, providing cloud maturity scores for improving cloud computing health. In particular, the present techniques may include methods, systems and computer-readable media that are directed to using machine learning-based techniques to generate respective values for cloud computing criteria, and for calculating cloud maturity scores based on the respective values.

For example, the present techniques may be used within the Inscape platform, an all-encompassing Cloud Business Platform of service offerings to help cloud computing customers discover, manage, govern, report, optimize, adopt, train, and procure the most popular Infrastructure-as-a-Service (IaaS)/Platform-as-a-Service (PaaS) and/or Software-as-a-Service (SaaS) offerings and applications. Inscape consolidates many tools and services for cloud management into a single view. The present techniques may provide include a single management and reporting platform (Inscape Cloud & SaaS Management) for Microsoft 365, Microsoft Azure, Amazon Web Services (AWS), Google Cloud Platform (GCP) and/or others, with a roadmap that expands into selected hyperscalers and SaaS solutions.

The present techniques provide the ability to provision, procure, manage, report, and unify the cloud and managed services billings. Because the present techniques include all of this cloud computing functionality in a single user interface, the present techniques advantageously increase productivity, control cloud costs, and mitigate cloud risks for clients. continue to consume more of these services. The present techniques improve productivity by having all of the functionality currently spread across many different portals in one single site with the ultimate goal of providing zero IT touch task management (e.g., on/offboarding through payroll software integration).

Further, the present techniques increase the productivity of their cloud administrators, eliminating the need for scripting one-offs, and providing have better cloud and software management, understanding cloud usage and cost, plus performance tracking and benchmarking. The present techniques may provide a single consolidated cloud invoice that allows cloud service consumers to easily reconcile and charge to the associated department, or project. The present techniques may also include cloud cost anomaly detection aspects that immediately alert customers and IT to an unusual spike in activity, advantageously enabling the consumers to immediately rectify such issues, without realizing a dramatic fiscal impact to the business.

The present techniques may provide cloud computing sales, management, reporting, governance, and optimization; all in one platform. The present techniques may provide the ability to procure cloud licensure/subscriptions and to have multi-cloud financial snapshots, including unified cloud invoicing, budgeting, cost anomaly detection, and ongoing helpdesk support.

### Exemplary Computing Environments

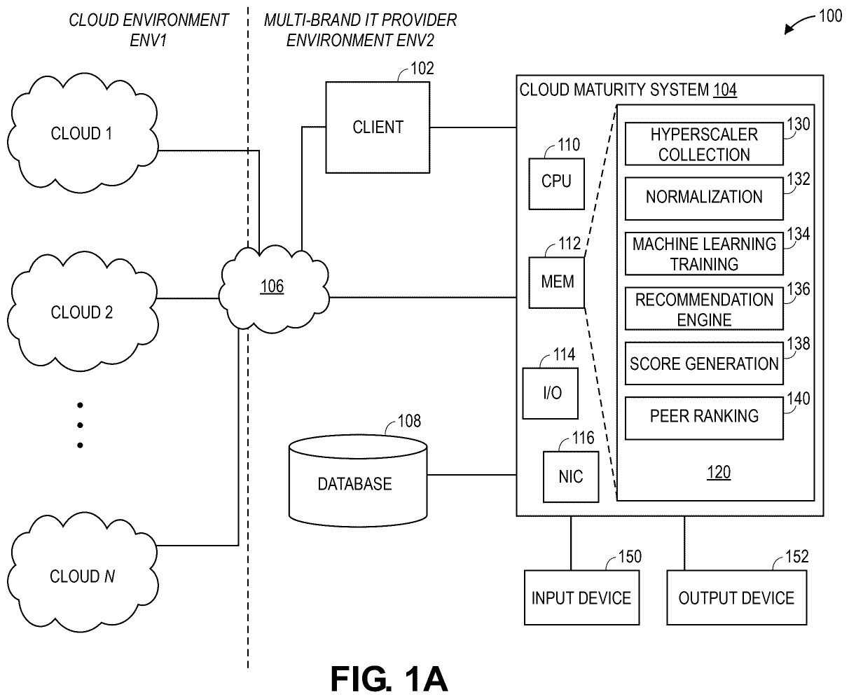

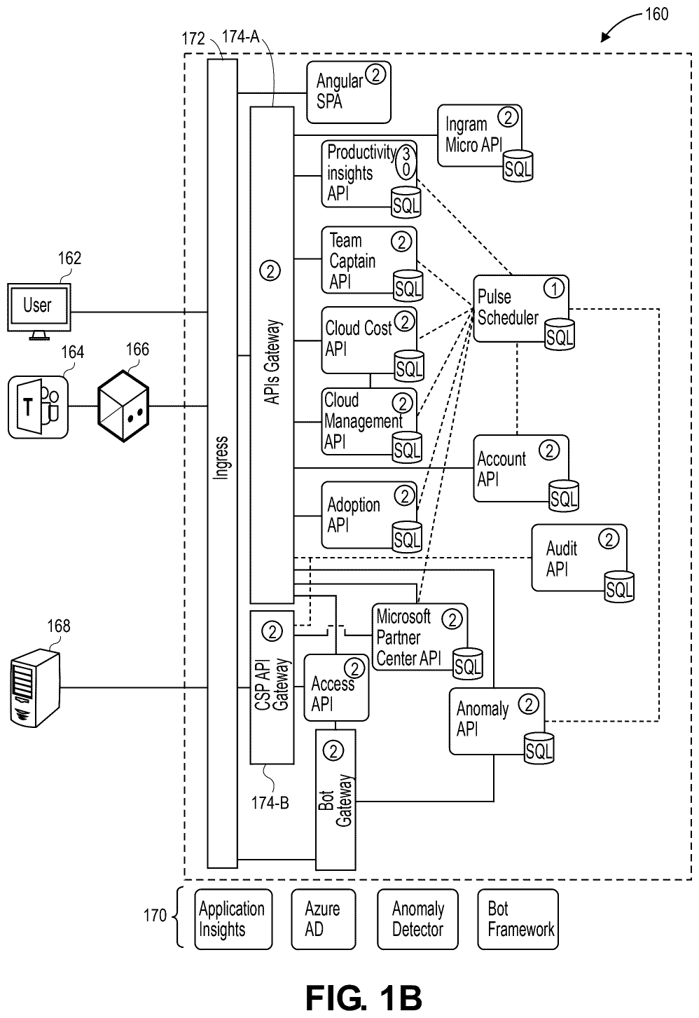

FIG. 1A depicts an exemplary computing environment 100, in which the techniques disclosed herein may be implemented, according to some aspects. The environment 100 includes a client computing device 102, a cloud maturity system 104, and a network 106. Some embodiments may include a plurality of client computing devices 102 and/or a plurality of systems 104. The computing environment 100 includes a cloud environment ENV1 and a multi-brand IT provider environment ENV2. The ENV1 may correspond to one or more public clouds, one or more private clouds and/or one or more hybrid clouds. For example, ENV1 may include a cloud 1, a cloud 2, etc. through a cloud n wherein n is a positive integer. For example, cloud 1 may be an AWS cloud, while cloud 2 is a GCP cloud, while cloud 3 is a Microsoft Azure cloud, and so on. Each of the clouds in the ENV1 may be accessible via the electronic network 106.

The client computing device 102 may be an individual server, a group (e.g., cluster) of multiple servers, or another suitable type of computing device or system (e.g., a collection of computing resources). For example, the client computing device 102 may be any suitable computing device (e.g., a server, a mobile computing device, a smart phone, a tablet, a laptop, a wearable device, etc.). In some embodiments, one or more components of the computing device 102 may be embodied by one or more virtual instances (e.g., a cloud-based virtualization service). In such cases, one or more client computing device 102 may be included in a remote data center (e.g., a cloud computing environment, a public cloud, a private cloud, etc.). One or more of the client computing devices 102 may be located in the ENV1.

The network 106 may be a single communication network, or may include multiple communication networks of one or more types (e.g., one or more wired and/or wireless local area networks (LANs), and/or one or more wired and/or wireless wide area networks (WANs) such as the Internet). The network 106 may enable bidirectional communication between the client computing device 102 and the cloud maturity system 104, and/or between multiple client computing devices 102, and/or between the cloud maturity system 104 and the clouds in the ENV 1, for example. As shown, the network 106 may include one or more overlapping or separate cloud computing networks, such as one or more public clouds, one or more private clouds and/or one or more hybrid clouds.

The client computing device 102 may include a processor and a network interface controller (NIC). The processor may include any suitable number of processors and/or processor types, such as CPUs and one or more graphics processing units (GPUs). The processor is configured to execute software instructions stored in a memory. The memory may include one or more persistent memories (e.g., a hard drive/solid state memory) and stores one or more set of computer executable instructions/modules. In general, a proprietor (e.g., developer) or customer user may access the cloud computing environments via the network 106 via the client 102.

The cloud maturity system 104 includes a processor 110, a memory 112, an I/O controller 114 and a NIC 116. The cloud maturity system 104 may access the database 108 via the networks/cloud environments 106. The database 108 may be a structured query language (SQL) database (e.g., a MySQL database, an Oracle database, etc.) or another type of database (e.g., a not only SQL (NoSQL) database). The cloud maturity system 104 may include a library of client bindings for accessing the database 508. The database 108 may be separate from any databases initialized as part of a cloud computing environment, whether or not on behalf of customer.

The processor 110 may include any suitable number of processors and/or processor types, such as CPUs and one or more graphics processing units (GPUs). The processor 110 is configured to execute software instructions stored in a memory 112. The memory 112 may include one or more persistent memories (e.g., a hard drive/solid state memory) and stores one or more set of computer executable instructions/modules, including a hyperscaler module 130, a data normalization module 132, a machine learning training module 134, a recommendation engine module 136, a score generation module 138 and a peer ranking module 140. Each of the modules may implement specific functionality related to the present techniques.

The hyperscaler module 130 may include sets of computer executable instructions for collecting data from one or more cloud environments (e.g., the clouds 1-n of ENV 1 in FIG. 1A).

Specifically, the hyperscaler module 130 may include a plurality of sets of executable instructions, wherein each is used to access an individual hyperscaler. For example, a first library of software routines, or bindings, may include a set of instructions for accessing information from an AWS cloud instance, while a second set of instructions for accessing a GCP cloud instance, and a third set of instructions for accessing an Azure cloud instance, and so on. It should be appreciated that the set of software libraries in the hyperscaler module 130 may be extended to support any cloud computing platforms or services. Herein, the data collected by the hyperscaler module 130 may be known as “cloud computing environment operation data.”

The sets of computer-executable instructions in the hyperscaler module 130 may include instructions for accessing information about the respective clouds in the cloud environment ENV1 programmatically. For example, the instructions may include instructions for enumerating and querying for statistical information pertaining to the number of cloud instances (e.g., virtual machines, databases, storage blocks, data volumes, IP addresses, etc.) in the cloud(s) of ENV1. The instructions may include instructions for determining usage metrics (e.g., CPU cycles consumed, memory/storage used, database usage, network transfer, API calls, etc.). The hyperscaler module 130 may store this statistical information in the database 108 and/or in the memory 112.

In some aspects, the hyperscaler module 130 may include computer-executable instructions (e.g., an application) that may be packaged and delivered to one or more of the clouds in the environment ENV1. For example, the application may include instructions for forking a daemon process that collects analytics from the respective clouds of the ENV1 and transmits the analytics to the cloud maturity system 104. The analytics may include statistics regarding any use of the respective clouds, such as network bandwidth usage, CPU load, data types, industry affiliations, etc. The application may process information to detect certain keywords, regular expression matches, etc. In some aspects, the application may include a machine learning model trained by the machine learning training module 134 that is specifically trained to detect patterns regarding certain types of information (e.g., information subject to HIPAA protection).

The normalization module 132 may include computer-executable instructions for processing the statistics received by the hyperscaler module 130 to normalize the statistics from different cloud providers, so that the statistics can be directly compared. For example, cloud 1 in the ENV1 may provide outbound data transfer rates in gibibytes per second (GB/s). Cloud 2 in the ENV1 may provide outbound data transfer rates in Gibibytes per second (GiB/s). The normalization module 132 may convert the latter to gigabytes/second so that the two values can be compared. The normalized data may be stored in the database 108 instead of, or along with, the unnormalized data. Other value conversions may be performed as well; for example, different cloud APIs may report information in different ways (e.g., using XML, JSON, or other markup/formatting languages). The normalization module 132 may include instructions for extracting/parsing values from formatted strings. For example, the TLS version of a web server may be reported in JSON in by one cloud provider, and in XML by another cloud provider. Or in JSON string in both instances, but in a flat data structure in the first instance, and in a nested data structure in the second instance; or in two different nested data structures. The normalization module 132 may include instructions for handling such differences to enable the creation of comparable data values. In this way, the normalization module 132 serves to improve information logging in a multi-cloud environment, by making logging of values from multi-cloud environments consistent.

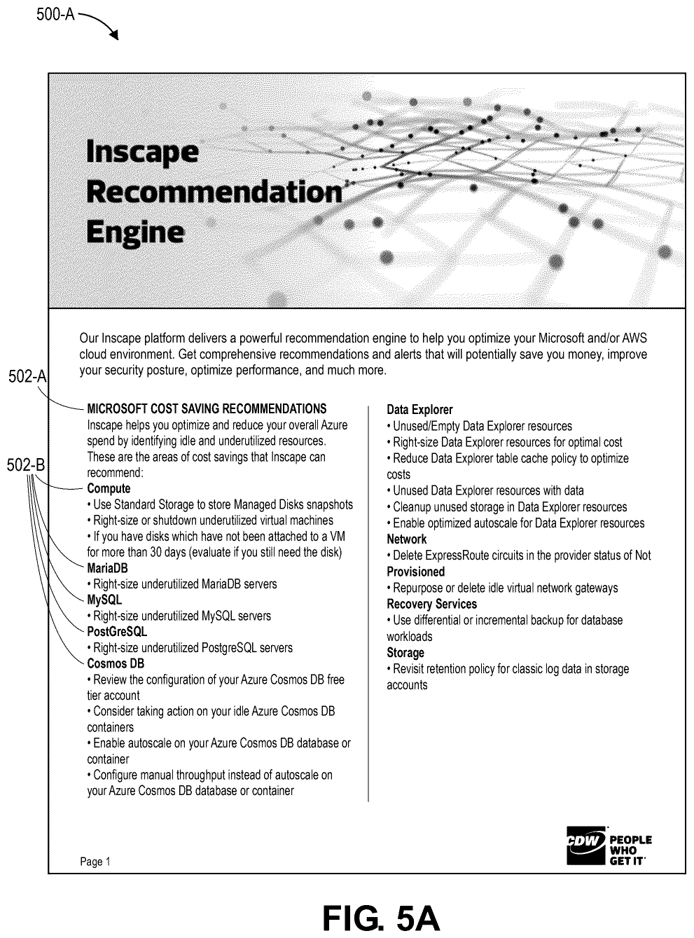

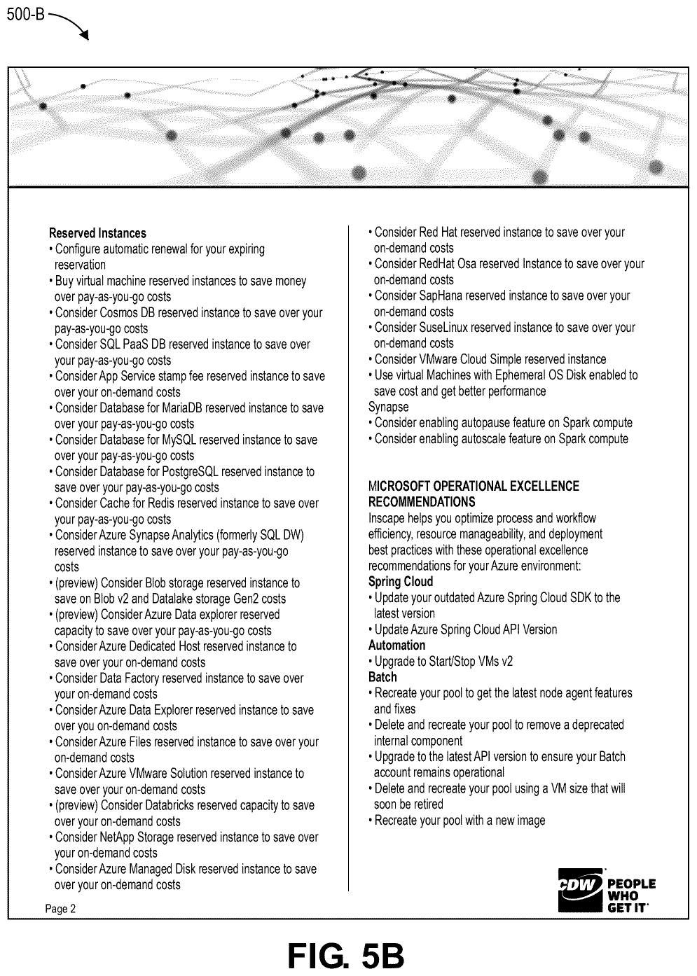

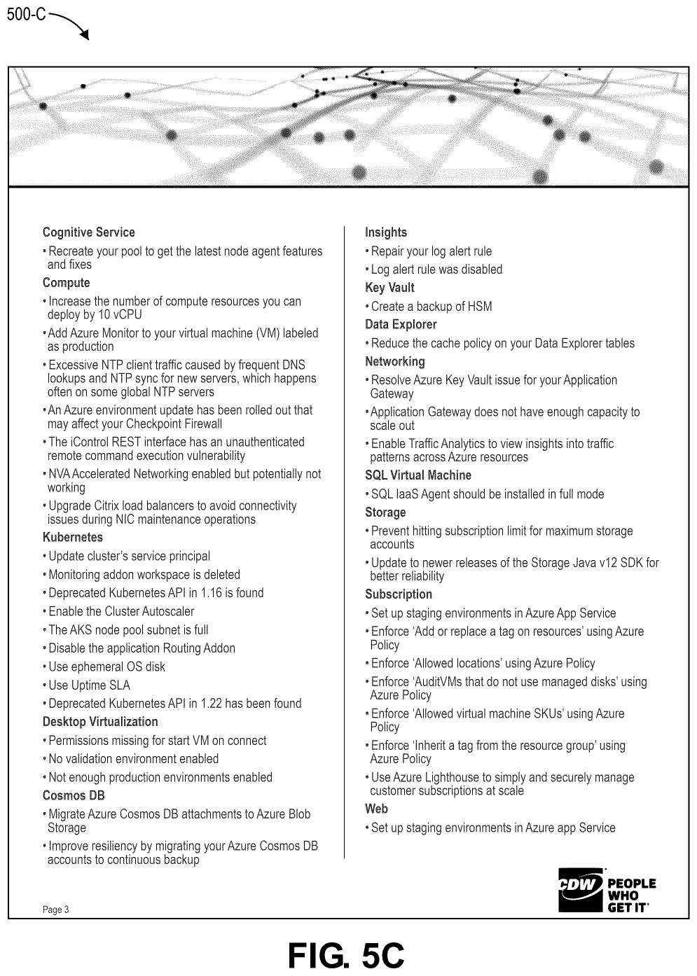

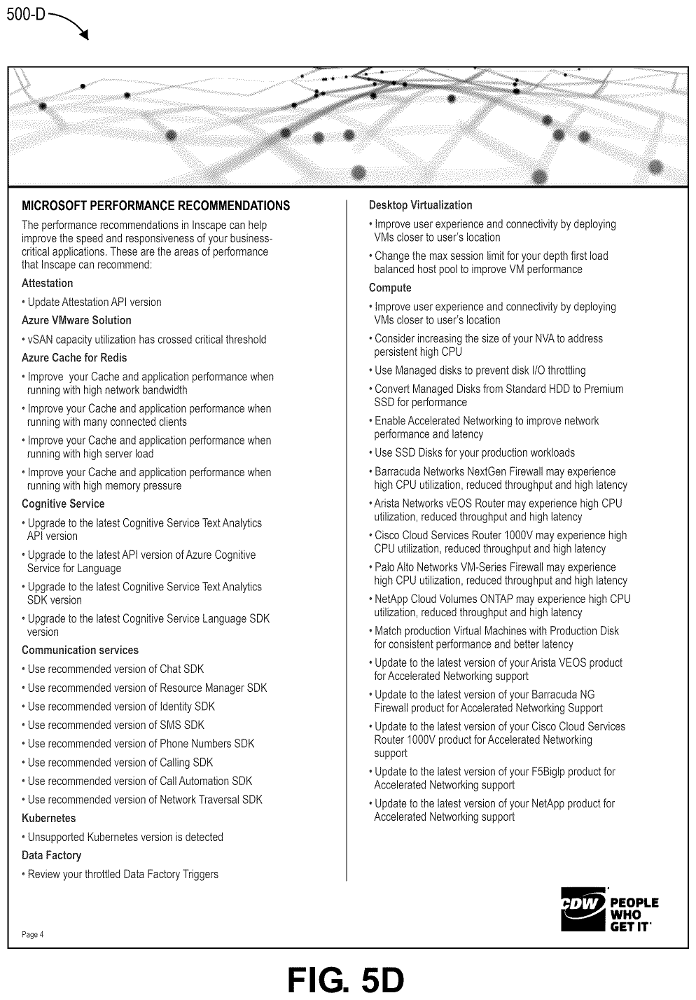

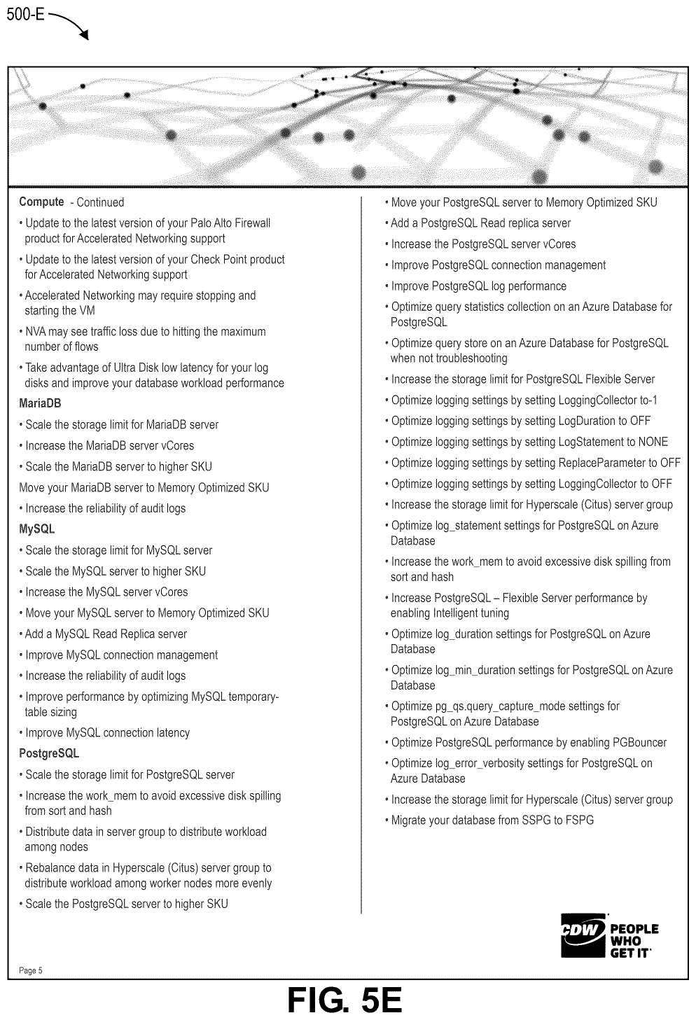

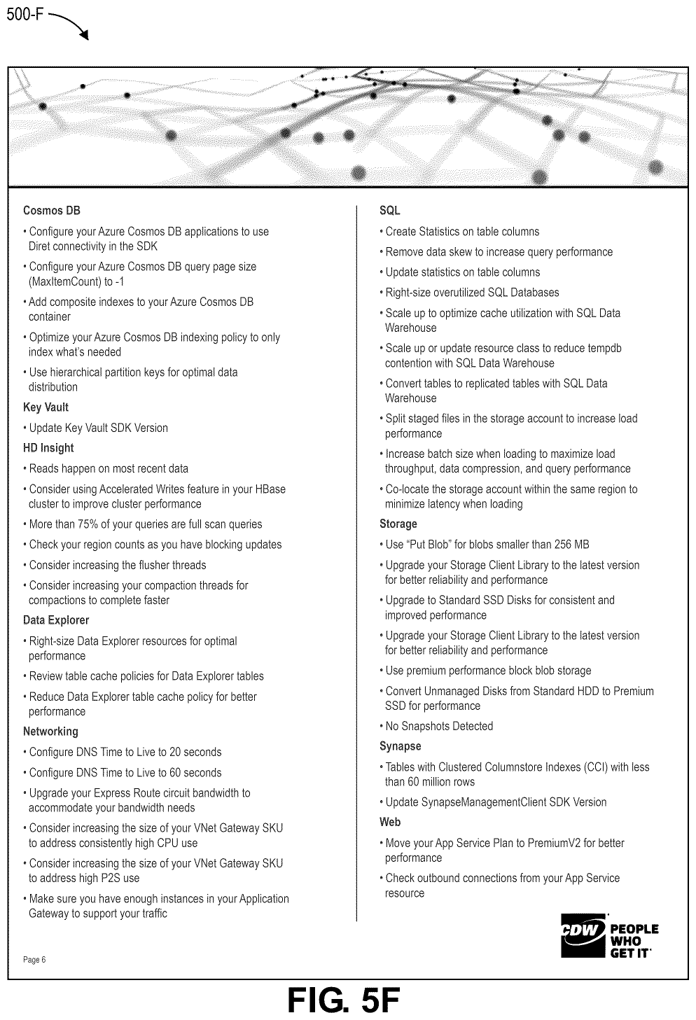

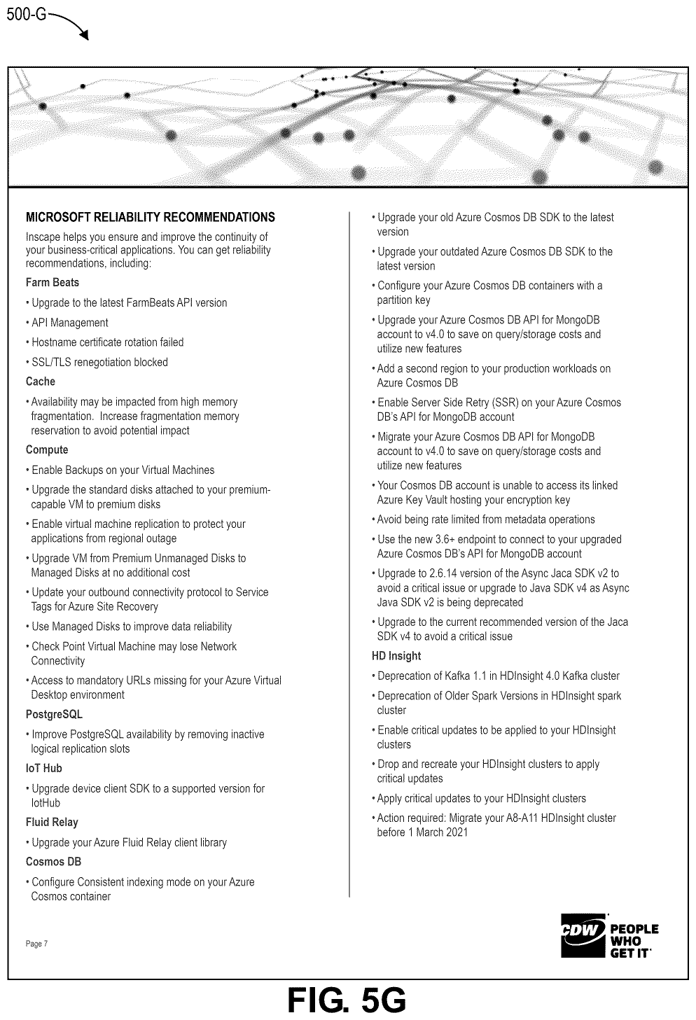

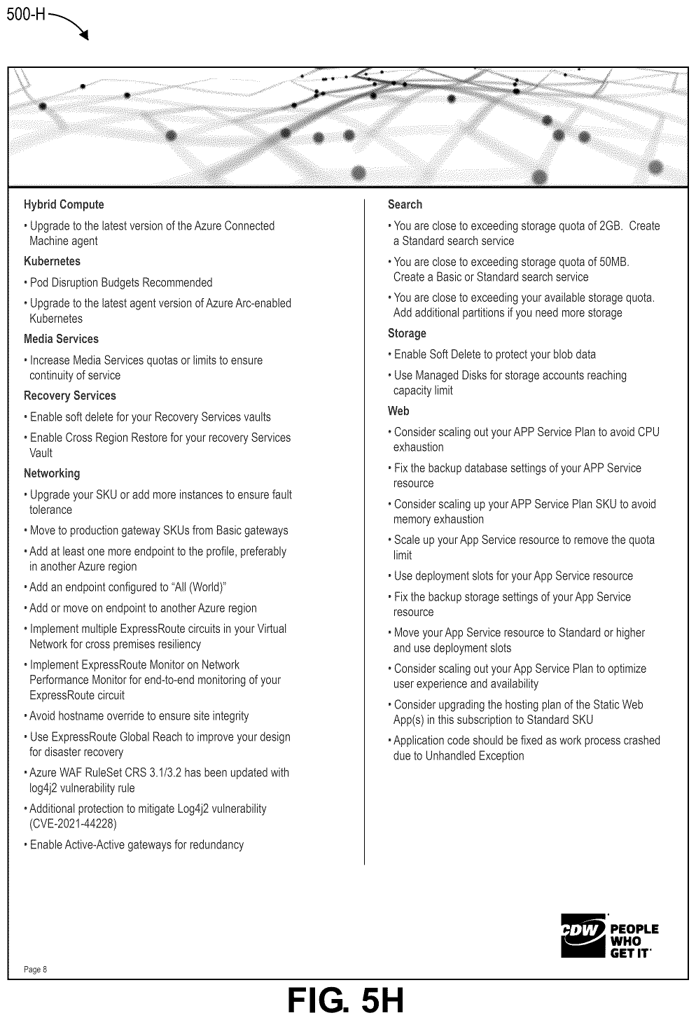

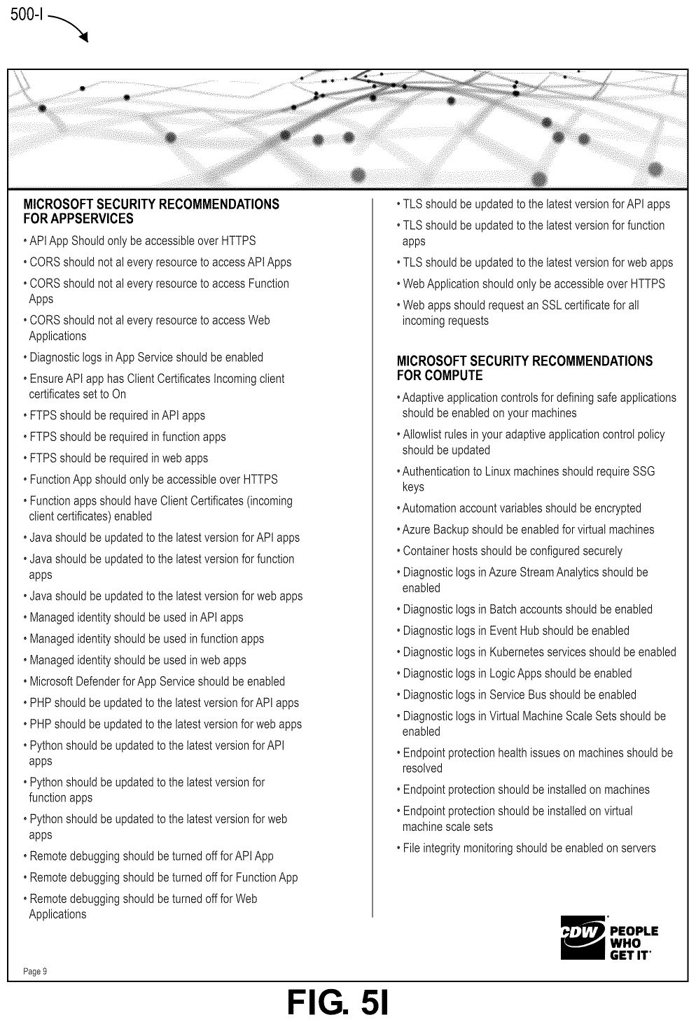

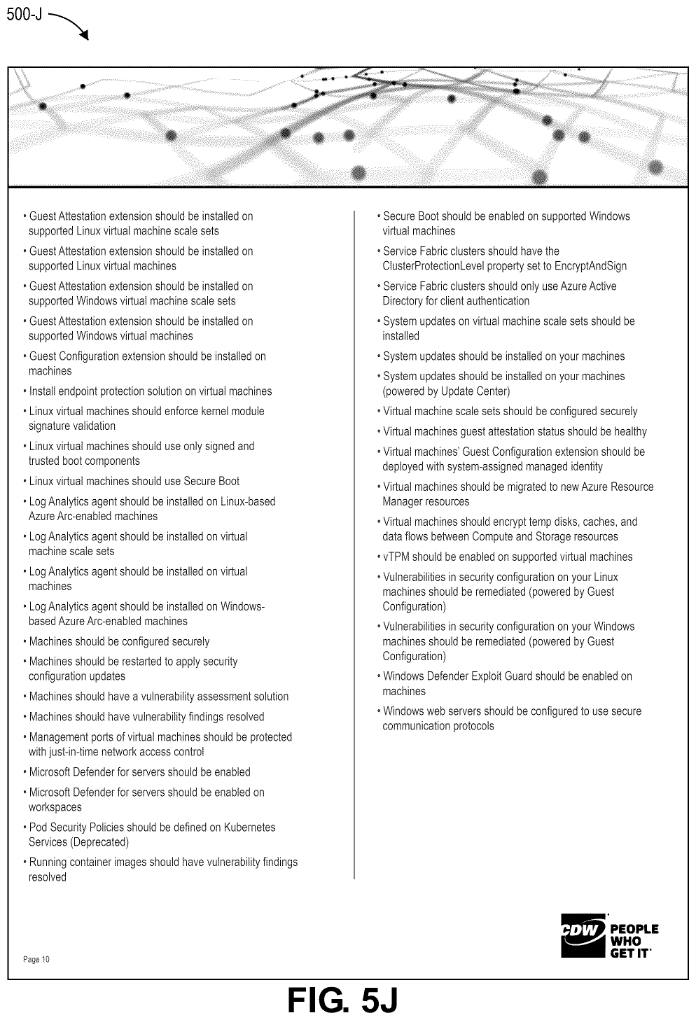

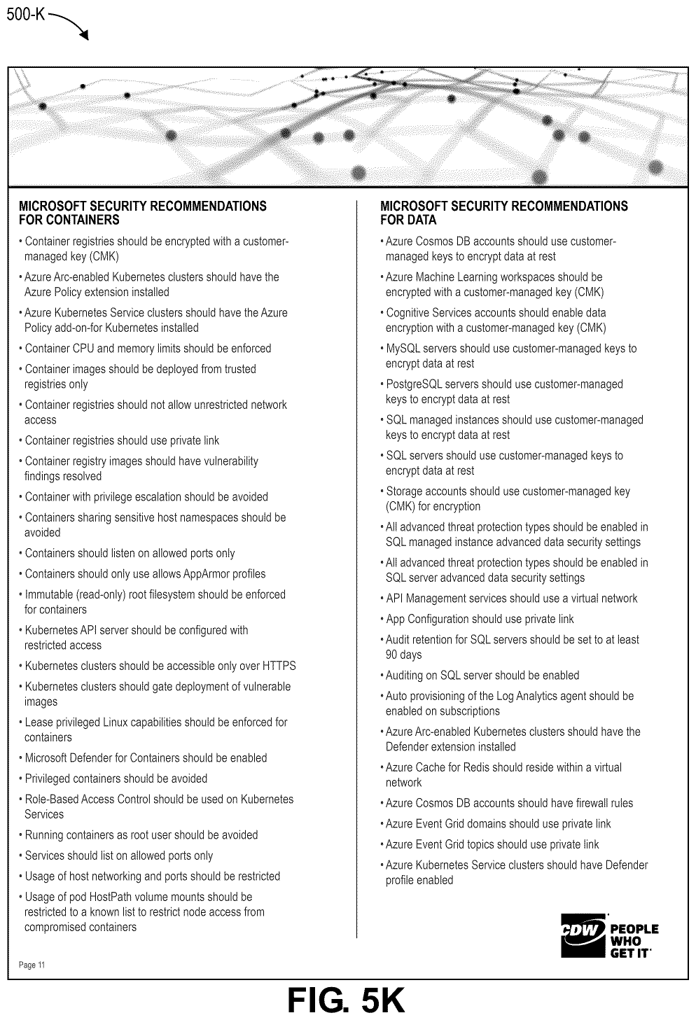

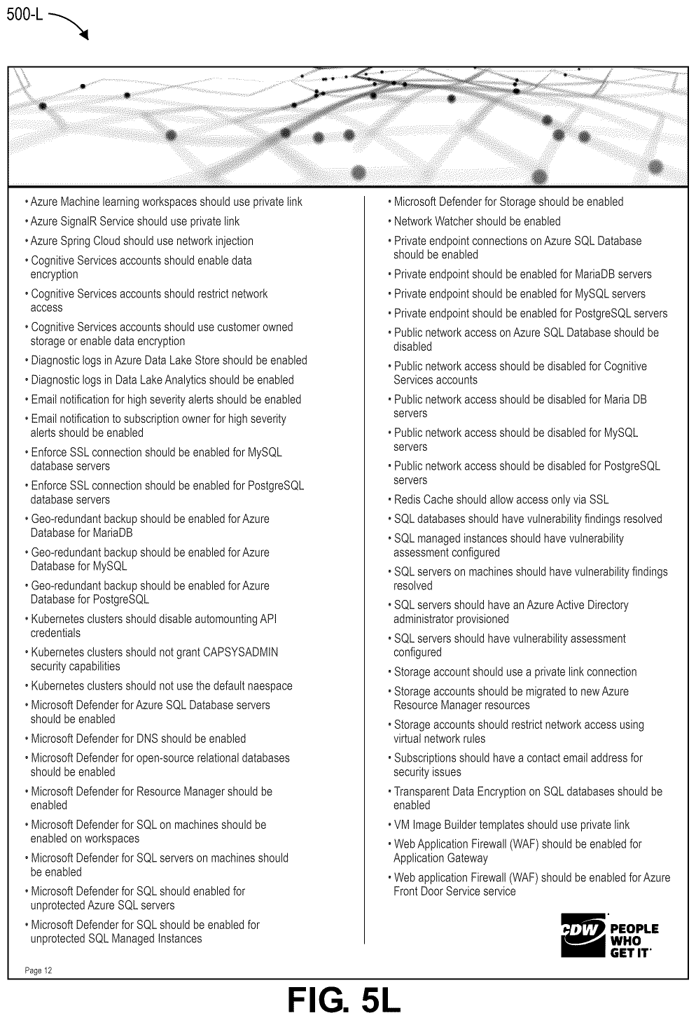

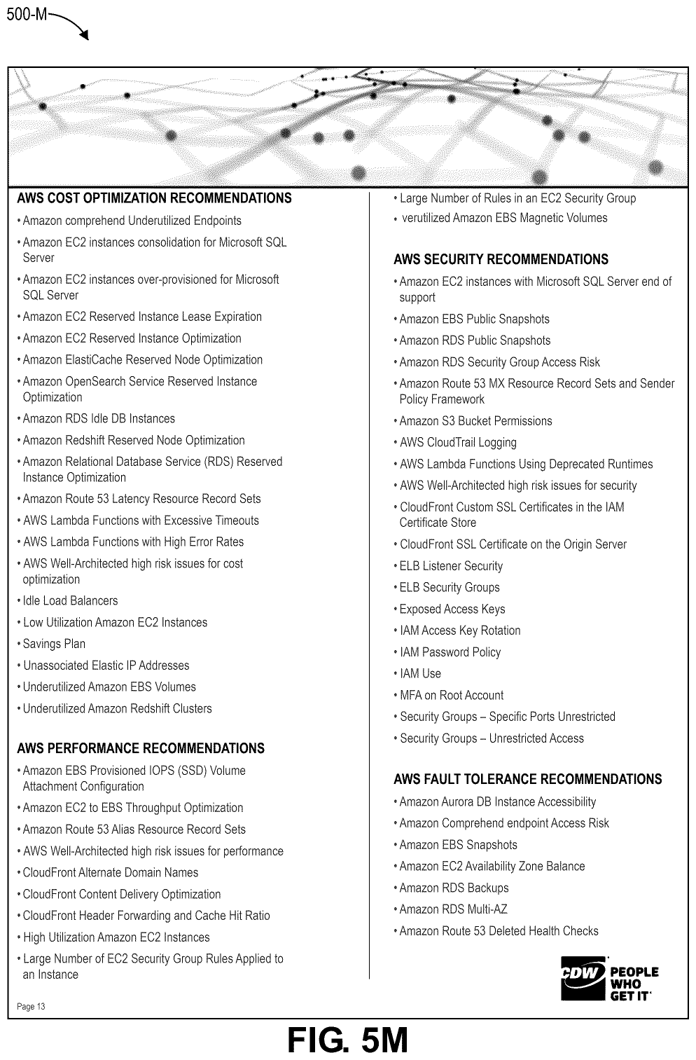

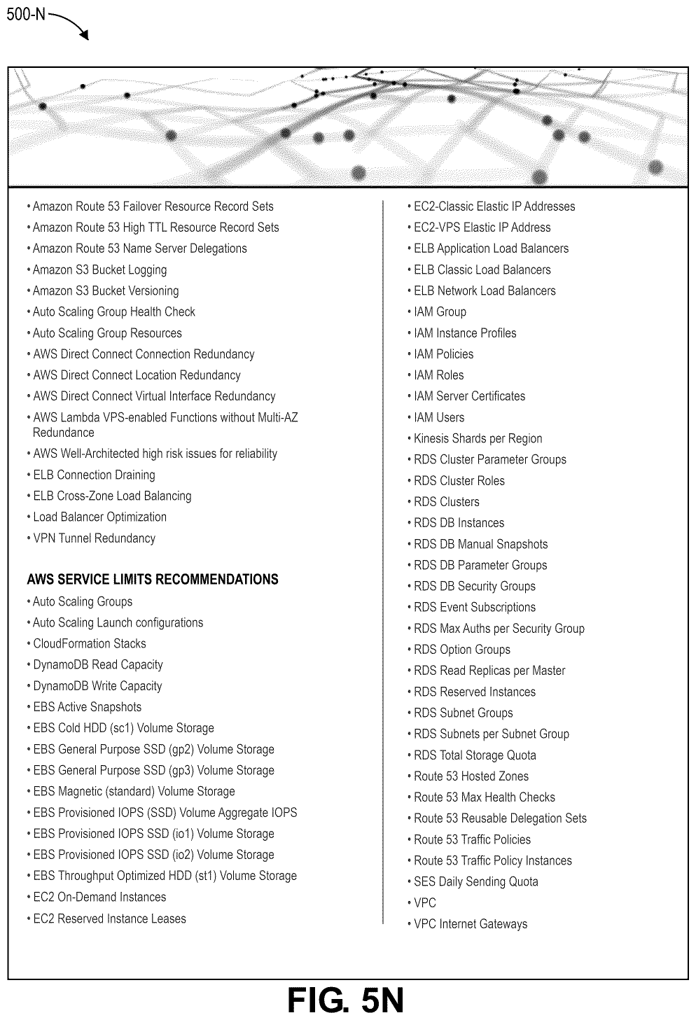

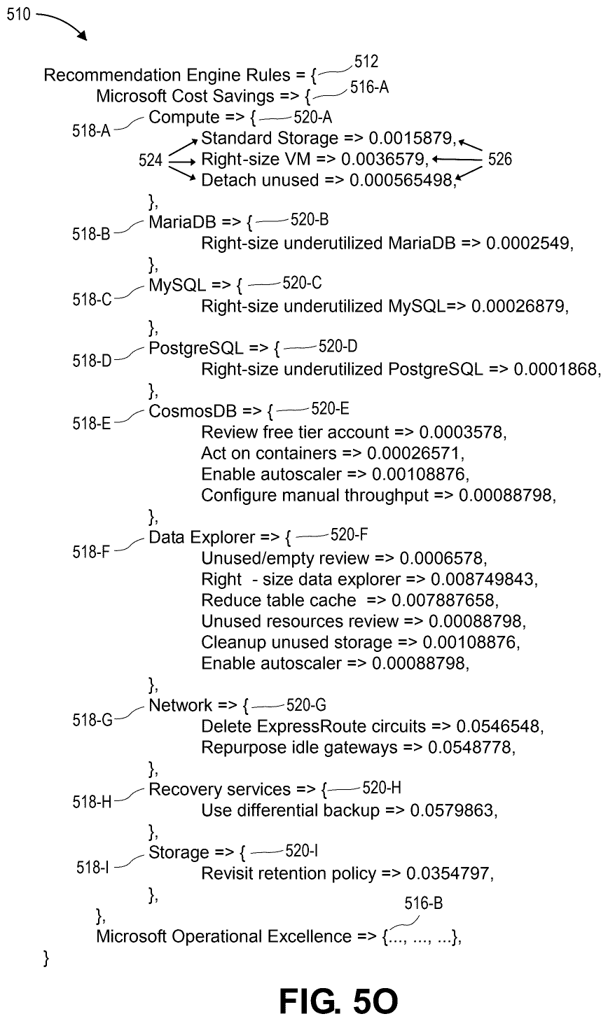

The machine learning training module 134 may include instructions for training one or more machine learning models. For example, the machine learning training module 134 may train one or more machine learning models to determine respective weights (also known as “priority scores”) for one or more recommendations. For example, a machine learning model may be trained (e.g., using historical data) to process a set of recommendations and to predict, for each recommendation, a respective weight or priority score, as discussed in further detail with respect to FIG. 5O. A subsequent processing step may use the respective weights/priority scores to compute one or more overall maturity scores, and/or to rank the recommendations based on the respective scores.

In some aspects, the machine learning training module 134 may train one or more generative pre-trained transformer (GPT) models. For example, the machine learning training module 134 may train a GPT model to receive and process data stored in the database 108, such as cloud computing data from one or more hyperscaler instances and/or status information corresponding to the hyperscalers determined via additional processing (e.g., using one or more ML models). In some aspects, the machine learning training model 134 may fine-tune an existing GPT model. The existing model may be, for example, an open source large language model (LLM) (e.g., Large Language Model Meta AI (LLaMA)) or another small-parameter or large-parameter LLM. The fine-tuning may include grounding a pre-trained model by providing additional training examples using a zero-shot or few-shot learning strategy.

Differing sets of training examples may be used to fine-tune one or more GPTs/LLMs in different ways. For example, cloud computing data may be stratified by industry, as discussed herein. Data for one industry (e.g., healthcare) may be selected and used to fine tune an LLM. This fine-tuned model may be called via an API and provided with information about a new customer. For example, the model could be parameterized using information about a newly onboarded customer in the healthcare industry. The model could be queried in a chat mode to ask questions about how the newly onboarded customer's cloud computing usage compares to that of existing healthcare customers. Additional criteria may be used to narrow the customer pool (e.g., healthcare entities with 400 beds or more). Other types of questions that could be answered, for example, relate to which services other comparable companies are using that the newly onboarded customer is not using.

As discussed, the present techniques are anticipated to support a large number of cloud environments (e.g., the cloud environment ENV1) having a large number of potentially heterogeneous clouds. Access to a large volume of data for many customers, across many industries, advantageously enables the present techniques to make comparisons between customer computing environments in those industries.

In some aspects, access to a GPT-based chat tool may be provided to customers, to enable the customers to chat regarding their cloud environments. For example, the customers may query for specifics regarding their cloud environment (e.g., number of instances, utilization rates, etc.). The customers may also request and receive information related to the rule group 502-A. For example, the customer may request information related to security recommendations, as depicted in FIG. 51. The GPT model may respond by displaying one or more recommendations that the user may perform in order to improve the user's cloud maturity score. The recommendations may be ranked and prioritized as discussed herein.

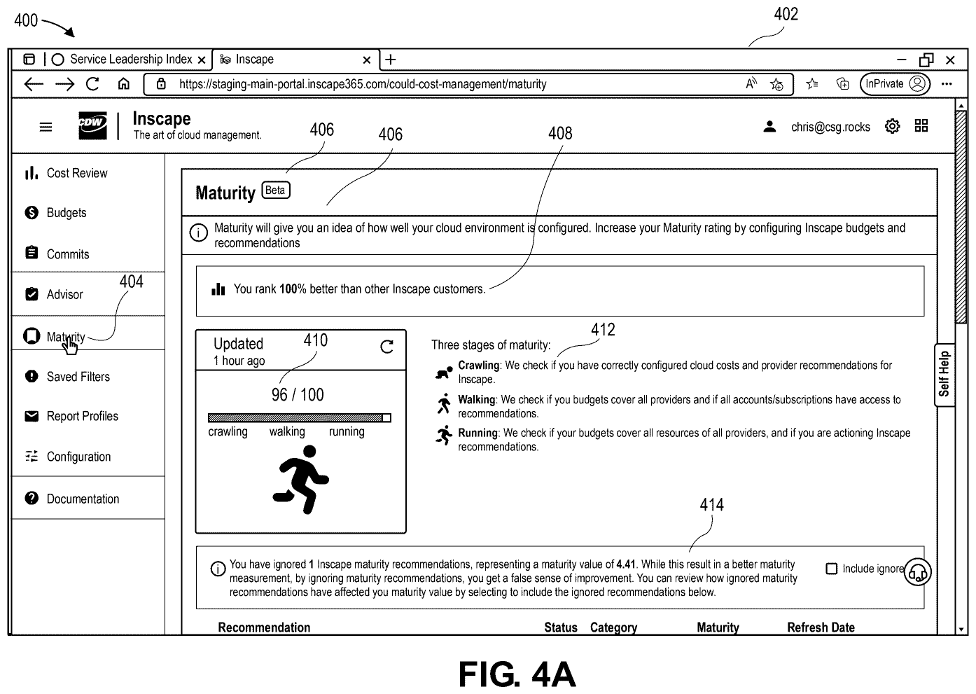

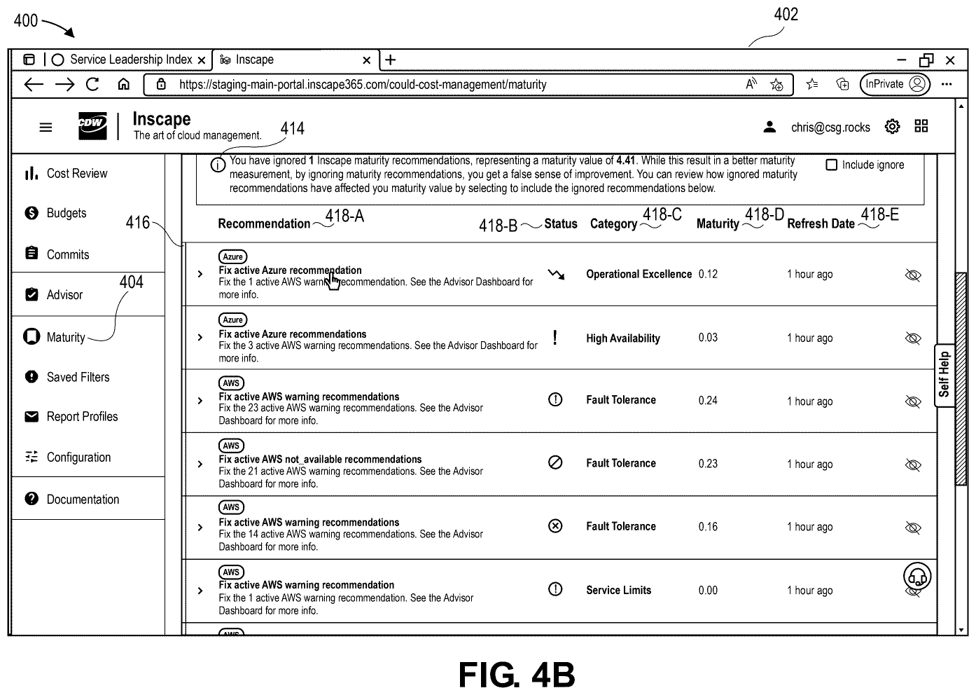

The recommendation engine 136 may include a set of computer-executable instructions for generating recommendations to improve cloud infrastructure of the user (e.g., the cloud environment ENV1). FIGS. 4A-4C depict examples of a cloud maturity score corresponding to the cloud computing infrastructure of the user, and FIGS. 5A-5N depict examples of recommendations that may be output by the recommendation engine 136. Each of the recommendations in FIG. 5A may include one or more respective values (e.g., an acceptable range), a Boolean flag, etc.

The recommendation engine 136 may generate the recommendations to improve cloud infrastructure of the user by accessing one or more trained machine learning model trained by the machine learning training module 134. Specifically, the recommendation engine 136 may generate a data structure including recommendations.

The recommendation engine 136 may include analyzing the cloud computing usage of the company/client to determine one or more patterns. In some cases, one or more machine learning models may be used to determine such patterns. For example, a trends module (not depicted) may determine that the company keeps 50% (or less) of cloud computing CPU utilization across a plurality of instances and/or across cloud compute providers. In that case, the recommendation engine may infer that the low utilization is intentional, and may adjust the set of weights corresponding to that customer/client, to customize the recommendations given to that client. In this case, the client would not receive a recommendation to downsize their instances, due to the desire of the client to maintain headspace in the cloud computing CPU, based on the pattern matching.

The score generation module 138 may include computer-executable instructions for generating scores, including a cloud maturity score. The cloud maturity score may be computed by evaluating a function that considers certain criteria/factors (e.g., the industry of the customer), and a plurality of weighted recommendations describing the customer's cloud environment. Score generation and the cloud maturity score are discussed further below. As discussed, the recommendation engine 136 may generate recommendations for performing actions to change individual scores based on rules that have respective weights. Once the customer's cloud computing instance(s) is scored individually using the plurality of rules, the score generation module may generate one or more maturity scores. A global maturity score may be generated that considers both the status of the user's environment, and weights established for one or more properties of the user's environment. The score generation module 138 may generate one or more scores based on the customer's environment type (e.g., development, production, test); based on the type of instances that the customer is using (e.g., by cloud provider); according to different projects/profiles established by the customer, as described herein, etc.

In some aspects, the score generation module 138 may apply a multiplier to weights based on a detected industry of the customer. For example, when the industry is healthcare, the score generation module may multiply recommendations related to protection of personally-identifiable information (PII) by a factor to account for the importance of protecting such information in the healthcare space. Many other industry-based and/or data based recommendations are envisioned. For example, in some aspects, a graphical user interface may enable the customer to select a resource utilization profile that corresponds to the customer's desired optimization criteria. For example, in some aspects, the customer may desire to optimize for low cost, in others, the customer may seek to preserve sufficient headroom in CPU, memory and other cloud computing resources to enable scaling, etc.

The peer ranking module 140 may include computer-executable instructions for collecting data based on activities of the clouds in the could environment ENV1. For example, the peer ranking module 140 may receive information from the hyperscaler module 130 and process the information to determine the purposes for which the cloud environment ENV1 is being used. In some aspects, the hyperscaler module 130 may receive information from an application executing in the cloud 1 (e.g., the daemon process discussed above). The peer ranking module 140 may include instructions for storing the received data and for processing the data to create comparable data. For example, the comparable data may include indications of industry affiliation (e.g., healthcare) analytics regarding the cloud environments. The industry may correspond to a client of the IT provider. In this way, the IT provider can learn the purpose for which the client is using one or more cloud(s) in the ENV1, and compare that usage across clients. This comparison may enable the IT provider to rank the usage of the different clients, and to provide maturity scores as discussed herein. Further, this comparison advantageously enables the IT provider to provide maturity scores that are customized to specific cloud resource use cases and/or environments, in contrast to systems that do not make such distinctions. Empirical testing has shown that this comparison data is powerful in helping the IT provider to improve customer rankings by recommending more efficient usage of cloud resources, for example, in a cloud consulting use case. Further, the more customers/clients that are added to the ENV1, the more insightful the comparison data becomes.

The input output controller 114 may include instructions for processing inputs from an input device 150 and for generating outputs for an output device 152. The input device 150 and the output device 152, respectively, enable input to be received from a user for example from a keyboard or mouse or other input device, and for outputs that correspond to be generated and transmitted to the output device. In some cases, the input device 150 and the output device 152 may be combined into a single device such as a capacitive touch screen.

FIG. 1B depicts an exemplary computing environment 160 for providing cloud maturity scores for improving cloud computing health to end users, according to some aspects. In some aspects, the environment 160 may correspond to the environment 100 of FIG. 1A. End users may access the environment 100 by multiple ingress routes. For example, the environment 160 may be accessible by a user device 162 (e.g., via an electronic network such as the network 106 of FIG. 1A). For example, the user device 162 may correspond to the user device 102 of FIG. 1A. The environment 160 may include one or more client applications 164 and one or more application proxies 166 (e.g., a SIP proxy). The computing environment 160 may include one or more external services 168, and one or more microservices, including docker containers, a Kubernetes management platform. Specific example services that may be used to implement the environment 160 in some aspects include Docker containers, Azure Kubernetes (AKS), SQL DB, Cosmos DB, Azure Service Bus, Azure Key Vault and Azure Storage.

The user devices, applications 164, application proxies 166 and external services 168, and microservices 170 may access the environment 160 via an ingress controller 172 (e.g., an NGINX controller). The ingress controller 172 may leverage Kubernetes, for example, to provide a scalable, manageable, and robust SaaS application that can be used as the hub for future “snap in” departmental development needs.

The ingress controller 172 may proxy access from external sources via one or more API gateways 174 (e.g., Ocelot API gateways). The ingress controller 172 and API gateways 174 may proxy access to internal APIs and/or SPAs. The environment 160 may include a billing engine that allows for proration of cloud/SaaS costs with the ability to bundle professional and managed services that can be invoiced on a monthly, quarterly, or annual basis. The billing engine may generate unified cloud invoices for customers and, on a monthly basis ingest billing information (e.g., CSV file into its accounting system).

The computing environment 160 of FIG. 1B may be a multi-tenant, Service Organization Control (SOC) II/Type II Certified Platform that provides unified single sign on, role-based access control, and multi-factor authentication with open REST APIs.

### Exemplary Computer-Implemented Machine Learning Model Training and Model Operation

In general, a computer program or computer based product, application, or code (e.g., the model(s), such as machine learning models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 110 (e.g., working in connection with the respective operating system in memory 154) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.).

For example, in some aspects, the ML model training module 134 may include a set of computer-executable instructions implementing machine learning training, configuration, parameterization and/or storage functionality. The ML model training module 134 may initialize, train and/or store one or more ML models, as discussed herein. The trained ML models may be stored in the database 108, which is accessible or otherwise communicatively coupled to the cloud maturity system 104. The modules 120 may store machine readable instructions, including one or more application(s), one or more software component(s), and/or one or more APIs, which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein.

The ML training module 134 may train one or more ML models (e.g., an artificial neural network (ANN)). One or more training data sets may be used for model training in the present techniques, as discussed herein. The input data may have a particular shape that may affect the ANN network architecture. The elements of the training data set may comprise tensors scaled to small values (e.g., in the range of (−1.0, 1.0)). In some aspects, a preprocessing layer may be included in training (and operation) which applies principal component analysis (PCA) or another technique to the input data. PCA or another dimensionality reduction technique may be applied during training to reduce dimensionality from a high number to a relatively smaller number. Reducing dimensionality may result in a substantial reduction in computational resources (e.g., memory and CPU cycles) required to train and/or analyze the input data.

In general, training an ANN may include establishing a network architecture, or topology, adding layers including activation functions for each layer (e.g., a “leaky” rectified linear unit (ReLU), softmax, hyperbolic tangent, etc.), loss function, and optimizer. In an aspect, the ANN may use different activation functions at each layer, or as between hidden layers and the output layer. A suitable optimizer may include Adam and Nadam optimizers. In an aspect, a different neural network type may be chosen (e.g., a recurrent neural network, a deep learning neural network, etc.). Training data may be divided into training, validation, and testing data. For example, 20% of the training data set may be held back for later validation and/or testing. In that example, 80% of the training data set may be used for training. In that example, the training data set data may be shuffled before being so divided. Data input to the artificial neural network may be encoded in an N-dimensional tensor, array, matrix, and/or other suitable data structure. In some aspects, training may be performed by successive evaluation (e.g., looping) of the network, using training labeled training samples. Over time, the cloud maturity system may receive data from cloud environments that are responding to changes in environmental conditions, which may cause the predictions of the machine learning models described herein to before more accurate in response to those environmental conditions over time.

The process of training the ANN may cause weights, or parameters, of the ANN to be created. The weights may be initialized to random values. The weights may be adjusted as the network is successively trained, e.g., using one or more gradient descent algorithms, to reduce loss and to cause the values output by the network to converge to expected, or “learned”, values. In an aspect, a regression may be used which has no activation function. Therein, input data may be normalized by mean centering, and a mean squared error loss function may be used, in addition to mean absolute error, to determine the appropriate loss as well as to quantify the accuracy of the outputs. In some aspects, the present techniques may include one or more ML models that perform a regression analysis.

In various aspects, an ML model, as described herein, may be trained using a supervised or unsupervised machine learning program or algorithm. The machine learning program or algorithm may employ a neural network, which may be a convolutional neural network, a deep learning neural network, and/or a combined learning module or program that learns in two or more features or feature datasets (e.g., structured data, unstructured data, etc.) in a particular areas of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques. In some aspects, the artificial intelligence and/or machine learning based algorithms may be based on, or otherwise incorporate aspects of one or more machine learning algorithms included as a library or package executed on cloud maturity system 104. For example, libraries may include the TensorFlow based library, the Pytorch library, and/or the scikit-learn Python library.

Machine learning may involve identifying and recognizing patterns in existing data (such as data risk issues, data quality issues, data sensitivity, resource usage, industry affiliation, data type, etc.) in order to facilitate making predictions, classifications, and/or identifications for subsequent data. Machine learning model(s), may be created and trained based upon example data (e.g., “training data”) inputs or data (which may be termed “features” and “labels”) in order to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based on the discovered rules, relationships, or model, an expected output.

For example, the ML training module 134 may analyze labeled historical data at an input layer of a model having a networked layer architecture (e.g., an artificial neural network, a convolutional neural network, a deep neural network, etc.) to generate ML models. The training data may be, for example, data collected from hyperscalers of one or more customers (e.g., those in similar industries). The historical data may include labels. During training, the labeled data may be propagated through one or more connected deep layers of the ML model to establish weights of one or more nodes, or neurons, of the respective layers. Initially, the weights may be initialized to random values, and one or more suitable activation functions may be chosen for the training process, as will be appreciated by those of ordinary skill in the art. One or more ML models may be trained to predict weights for addressing issues related to cloud computing instances. The ML training module 134 may include training a respective output layer of the one or more machine learning models. The output layer may be trained to output a prediction, for example, or to output a number (e.g., a weight). In some aspects, multiple ANNs may be separately trained and/or operated. In some aspects, the present techniques may include using a machine learning framework (e.g., Keras, scikit-learn, etc.) to facilitate the training and/or operation of machine learning models.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated. In the present techniques, unsupervised learning may be used, inter alia, for natural language processing purposes and to identify scored features that can be grouped to make unsupervised decisions (e.g., numerical k-means). Supervised learning and/or unsupervised machine learning may also comprise retraining, relearning, or otherwise updating models with new, or different, information, which may include information received, ingested, generated, or otherwise used over time. The present techniques may use one or both of such supervised or unsupervised machine learning techniques. In various aspects, training the ML models herein may include generating an ensemble model comprising multiple models or sub-models, comprising models trained by the same and/or different AI algorithms, as described herein, and that are configured to operate together.

Once the model training module 134 has initialized the one or more ML models, which may be ANNs or regression networks, for example, the model training module 134 trains the ML models by inputting labeled data into the models.

The model training module 134 may divide the labeled data into a respective training data set and testing data set. The model training module 134 may train the ANN using the labeled data. The model training module 134 may compute accuracy/error metrics (e.g., cross entropy) using test data and test corresponding sets of labels. The model training module 134 may serialize the trained model and store the trained model in a database (e.g., the database 108). The model training module 134 may train and store more than one model. For example, the model training module 134 may train an individual model for each customer type, cloud instance type, industry type, etc. It should be appreciated that the structure of the network as described may differ, depending on the aspect.

In some aspects, the computing modules 120 may include a machine learning operation module (not depicted), comprising a set of computer-executable instructions implementing machine learning loading, configuration, initialization and/or operation functionality. The ML operation module may include instructions for storing trained models (e.g., in the electronic database 108, as a pickled binary, etc.). Once trained, a trained ML model may be operated in inference mode, whereupon when provided with de novo input that the model has not previously been provided, the model may output one or more predictions, classifications, etc. as described herein. In an unsupervised learning aspect, a loss minimization function may be used, for example, to teach a ML model to generate output that resembles known output (i.e., ground truth exemplars).

Once the model(s) are trained by the model training module 134, the model operation module may load one or more trained models (e.g., from the database 108). The model operation module may apply new data that the trained model has not previously analyzed to the trained model. For example, the model operation module may load a serialized model, deserialize the model, and load the model into memory. The model operation module may load new cloud data that was not used to train the trained model. The model operation module may apply the one or more input tensor(s) to the trained ML model. The model operation module may receive output (e.g., tensors, feature maps, etc.) from the trained ML model. The output of the ML model may be a prediction of a weight for addressing a cloud status/action. In this way, the present techniques advantageously provide a means for the company to quantitatively determine the impact to cloud maturity of addressing certain problems, and to triage a cloud environment, without resorting to “best guesses” or other subjective metrics used in conventional industry practices.

The model operation module may be accessed by another element of the cloud maturity system 104 (e.g., a web service). For example, the ML operation module may pass its output to the recommendation engine 136 for further processing/analysis.

In some aspects, the modules 120 may include more or fewer modules. For example, in some aspects, the modules 120 may include instructions for performing a migration once a suitable migration plan has been identified.

In operation, a user (e.g., a cloud engineer, cloud technician, IT/cloud computing administrator, etc.) accesses the cloud maturity system 104, for example, from the client 102. The client 102 may be a laptop, a desktop, a mobile device, etc. of the user. In some aspects, the user may access the cloud maturity system 104 via the input device 150 (i.e., by directly accessing the cloud maturity system 104). The cloud administrator may be seeking to analyze data collected from one or more hyperscalers such as the hyperscalers operating cloud 1-cloud n of ENV1.

In some aspects, the client 102 provides access to a customer of the cloud maturity system 104. The client 102 may enable the user to access a cloud maturity score generated by the score generation module 138. As discussed, the hyperscaler module 130 may run periodically or continuously, collecting information and storing it in the database 108. The normalization module 132 may process the information collected by the hyperscaler collection module 130 such that the data can be compared in an apples-to-apples manner across cloud providers, which is an advantage of the present techniques, as discussed herein.

The recommendation engine 136 may process the collected information and determine the status of one or more actions or states with respect to the individual hyperscalers, as discussed in further detail below. The score generation module 138 may generate one or more cloud maturity scores as discussed herein for example by evaluating whether each of the recommendations generated by the recommendation engine 136 have been addressed or not in the user's respective cloud computing environment(s). Different scores may be generated for different subsets of the user's environment.

The peer ranking module 140 may compare these score or scores of the user to those of all other users or some other users. The cloud maturity scores and peer rankings may be depicted and displayed on graphical user interfaces that are provided to the user for example via the client 102. One or more machine learning models trained by the machine learning training module 134 may update weights used to compute the user's cloud maturity score(s).

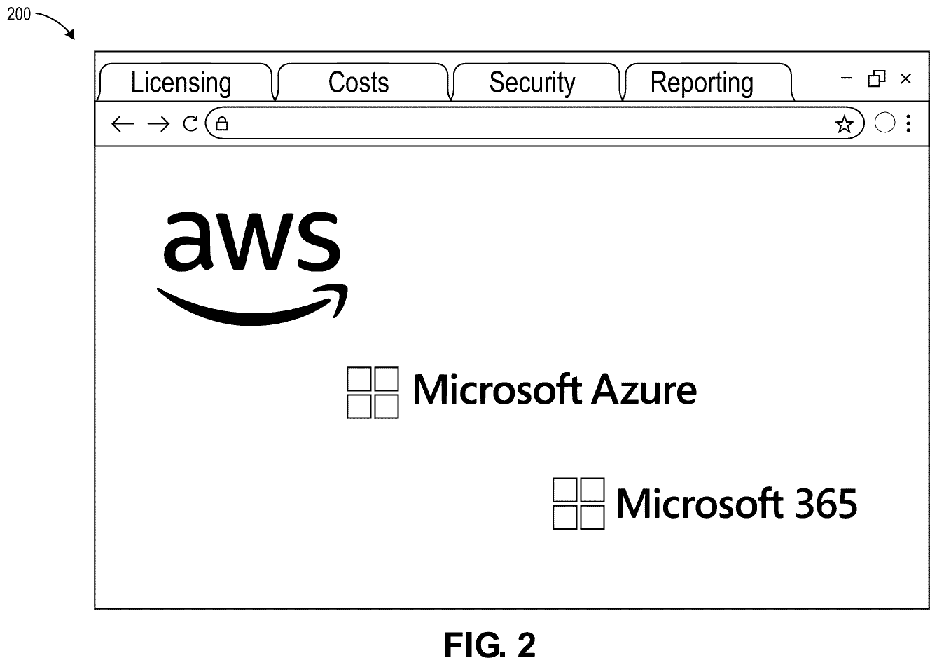

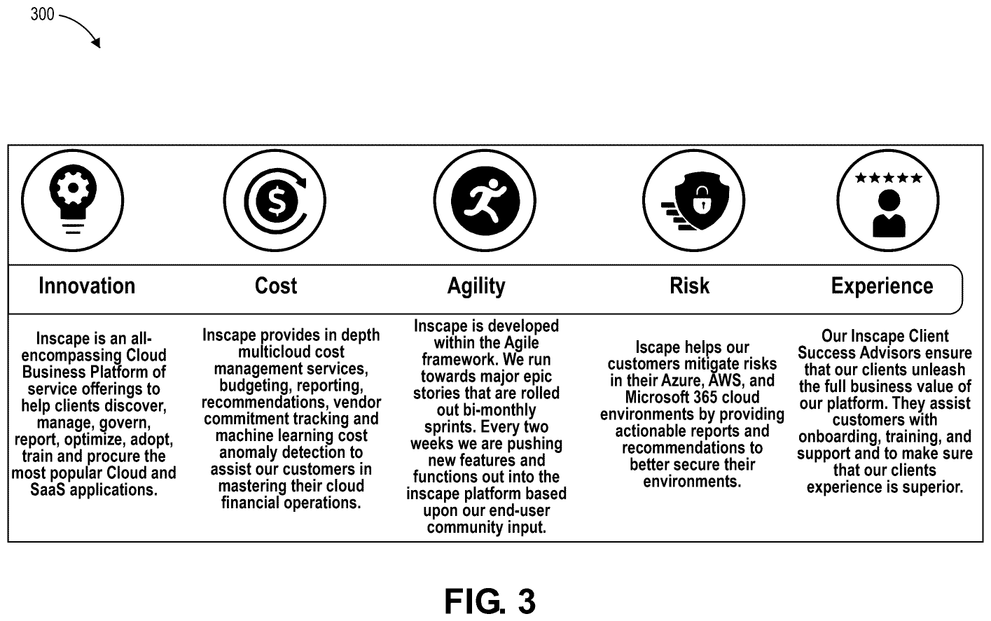

FIG. 2 depicts exemplary cloud computing environments accessible by the computing environment of FIG. 1A and the computing environment of FIG. 1B, according to some aspects. FIG. 3 depicts a block diagram of functionality provided by the exemplary cloud computing environment of FIG. 1A and/or FIG. 1B, according to some aspects.

### Exemplary Cloud Maturity Score Graphical User Interfaces

FIG. 4A depicts a cloud management platform including a cloud environment maturity graphical user interface 400. The cloud environment maturity graphical user interface 400 may include a cloud environment maturity window 402 and a cloud environment maturity tab 404.

When the user accesses the cloud environment maturity tab 404, the cloud environment maturity graphical user interface 400 may display a maturity score window 406.

The maturity score window 406 may include a peer comparison region 408, a numerical cloud maturity score 410 and a categorical cloud maturity score 412, according to some aspects.

The numerical cloud maturity score 410 and/or the categorical cloud maturity score 412 may include respective “crawl-walk-run” maturity stage indicators, as shown, which may include textual and/or graphical labels/indicators. The crawl-walk-run model is helpful to users, and is integrated with the overall invention.

As an example, a user may set up one or more profiles. The present techniques will then rank the customer's maturity level based on implementing the recommendations that the recommendation engine module 136 is providing. For instance, if the recommendation engine module 136 gives the customer 10 recommendations on how to reduce cloud spend but the customer implements up to 50% of them, they will receive a crawl maturity status. For 75% implemented, the customer will receive a walk status, and 90% completed would result in a run status. In aspects, the present techniques may use other measures to assign crawl-walk-run scores. For example, if a customer has 10 cloud accounts, cloud subscriptions and/or projects but less than 50% of them are associated with a profile, they will receive a Crawl Maturity level. When they get to 75% of them assigned to a profile, they will receive a Walk maturity level. Upon 90% included in the profile, they will receive a run maturity status. Moreover, the present techniques may determine the maturity Level of staying within budget.

Continuing the example, of the 10 profiles, if 50% are over their budgets they will be at crawl level, if 25% are over budget they will be at walk, and if less than 10% are over budget they will be at run level. The score generation module 138 may include a plurality of tables that score the foregoing percentage thresholds with respect to different cloud accounts and profiles. In some aspects, different accounts may be assigned different percentages. For example, a given customer may be considered to be at a walk stage at 10% over budget for GCP, but at a crawl stage at 10% over Azure, due to external factors (e.g., price differences). The threshold percentages may be assigned for any cloud properties, as discussed in the next section. In still further aspects, the user's implementation of recommendations alone may be used to populate the crawl-walk-run indicator, the peer comparison region 408, the numerical cloud maturity score 410 and/or the categorical cloud maturity score 412.

The maturity score window 406 may further include a warning region 414 that includes notifications regarding one or more ignored or unapplied recommendations, along with an option to ignore such recommendations.

FIG. 4B depicts the cloud management platform including the cloud environment maturity graphical user interface 400 of FIG. 4A. FIG. 4B depicts the result of the user having scrolled down in the maturity score window 406, past the warning region 414, which is also depicted in FIG. 4B.

In the example shown, beneath the warning region 414 is depicted a recommendations table 416, wherein each row corresponds to a recommendation generated by the recommendation engine module 136 of FIG. 1A. The recommendations relate to the one or more cloud environments of the logged in user (e.g., chris@csg.rocks, as in the example depicted in FIG. 4B). The recommendations table is composed of several columns, including a recommendation description column 418-A, a recommendation status column 418-B, a recommendation category column 418-C, a maturity score column 418-D, and a timestamp column 418-E.

By viewing the recommendations table 416, the user can get a quick sense of the user's recommendations, across multi-cloud environments. That is, advantageously, the user can view, in the single user interface of FIG. 4B, recommendations in multiple environments provided by different cloud providers (AWS and Azure as in the depicted example) that normally would require the user to login to multiple websites to perform the “swivel chair integration” discussed above. Thus, the graphical user interface 400 represents a significant improvement over conventional cloud management techniques, by specifically improving the cloud computing management user interfaces, by enabling them with multi-provider, one-stop management.

The graphical user interface 400 of FIG. 4A and FIG. 4B enables the user to quickly establish a base line of where the client is today by looking at all of their AWS Accounts, Azure Subscriptions and GCP Projects. The columns of the recommendations table 416 gives the user a high-level of which categories problems are occurring in, the magnitude of those problems (stated differently, how much the user's score can be improved by addressing those problems), the age of those problems, etc.

It should be appreciated that the present techniques may drive service sales. For example, throughout the maturity life cycle, the IT services provider may provide consulting advice on how to improve and move to the next cloud maturity level. This is another example of improving the technology of cloud services delivery, by improving managed services opportunities. Many clients will want to be at the run stage but just do not have time/resources to devote to solving the problems/adopting the recommendations, and will rely on the IT solutions provider to adopt those recommendations on their behalf. To that end, the graphical user interface 400 may include an element (e.g., “adopt all recommendations”) that causes the cloud maturity system 104 to automatically update the client's one or more cloud computing environments in the ENV1. In response to receiving such a selection, the cloud maturity system 104 (e.g., the hyperscaler module 130) may cause, via one or more APIs, the cloud environments ENV1 of the user/customer to be modified to adopt the recommendations. In some aspects, the graphical user interface 400 may enable the user to select one or more recommendations, rather than all of the recommendations, and to cause only those selected recommendations to be applied to the cloud environment ENV1.

### Exemplary Cloud Recommendation Engine Rules

FIG. 4A depicts a cloud management platform including a cloud environment maturity graphical user interface including exemplary numerical and categorical cloud maturity scores, according to some aspects.

FIG. 4B depicts a cloud management platform including a cloud environment maturity graphical user interface including exemplary recommendations for improving cloud maturity scores, according to some aspects.

FIG. 5A depicts exemplary cloud computing environment best practice rules 500-A (e.g., Microsoft Cost Savings Recommendations), according to some aspects. FIG. 5A includes a rule group 502-A, a plurality of rule categories 502-B (e.g., Compute, MariaDB, MySQL, etc.) each of which includes one or more respective rulesets (e.g., “Use Standard Storage to store Managed Disks snapshots,” “Right-size or shutdown underutilized virtual machines,” etc. The remainder of rule groups and rule categories are not labeled, but the structure of those categories and rulesets should be clear to the reader.

Each of the rulesets may be associated with one or more values (not depicted) that describe optimal values, in some aspects. For example, “Use Standard Storage to store Managed Disks snapshots” may be associated with a status value of True (e.g., in the database 108), such that the recommendation engine module 136 can determine whether the current status of a cloud environment in the ENV1 is an optimal value, or not. The associated values may include Boolean values, integer values, character values and/or values of specific higher order data types (e.g., a string, an object, etc.).

Further, as described with respect to FIG. 5O, each of the rulesets may be associated with values (not depicted) that describe the respective maturity score associated with performing each of the actions referenced in the rulesets. For example, again with reference to FIG. 5A, Right-sizing an underutilized MySQL server may include a False status value, and a maturity score of 0.00026879, as shown in ruleset 520-C of FIG. 5O, wherein the maturity score represents an increment or factor that will be applied to the user's maturity score if/when the user (or the IT services company) adopts the action recommended by the ruleset.

FIG. 5B depicts additional exemplary cloud computing environment best practice rules 500-B, according to some aspects. FIG. 5C depicts additional exemplary cloud computing environment best practice rules 500-C, according to some aspects. FIG. 5D depicts additional exemplary cloud computing environment best practice rules 500-D, according to some aspects. FIG. 5E depicts additional exemplary cloud computing environment best practice rules 500-E, according to some aspects. FIG. 5F depicts additional exemplary cloud computing environment best practice rules 500-F, according to some aspects. FIG. 5G depicts additional exemplary cloud computing environment best practice rules 500-G, according to some aspects. FIG. 5H depicts additional exemplary cloud computing environment best practice rules 500-H, according to some aspects. FIG. 51 depicts additional exemplary cloud computing environment best practice rules 500-1, according to some aspects. FIG. 5J depicts additional exemplary cloud computing environment best practice rules 500-J, according to some aspects. FIG. 5K depicts additional exemplary cloud computing environment best practice rules 500-K, according to some aspects. FIG. 5L depicts additional exemplary cloud computing environment best practice rules 500-L, according to some aspects. FIG. 5M depicts additional exemplary cloud computing environment best practice rules 500-M, according to some aspects. FIG. 5N depicts additional exemplary cloud computing environment best practice rules 500-N, according to some aspects.

### Exemplary Cloud Computing Maturity Rules Engine

FIG. 5O depicts exemplary cloud computing rules 510 including the best practices of FIGS. 5A-5N paired with respective computed weight values in a nested data structure used by a recommendation engine (e.g., the recommendation module 136 of FIG. 1A), according to some aspects. The rules 510 may include one or more static and/or dynamic values associated with one or more actions.

Specifically, the rules 510 are depicted in FIG. 5O as being encoded in a nested dictionary data structure 512 (e.g., a nested hash table). The dictionary 512 has first keys 514 that represent a high level grouping of rule types (e.g., Cost Savings, Operational Excellence, etc.) and first values 516 that include one or more further sub-dictionaries 516 representing rule categories. For example, the values 516-A correspond to the rule group 502-A of FIG. 5A, and the values 518-A through 518-E correspond, respectively, to the rule categories 502-B of FIG. 5A.

Specifically, the dictionaries/lists of rules 516 include second keys 518 describing a ruleset name, each corresponding to second values 520 that include one or more key/value rule pairs, each key-value pair having a respective key 524 representing an action to take (or not take) by the company, and a respective value 526 representing a corresponding weight for taking (or not taking) the action with respect to a cloud computing environment. In some aspects, the weights may be negative numbers, indicating a penalty for taking an action, or zero (representing neutrality of the action). The values 526 may respectively be static values, or in some aspects, determined dynamically.

For example, in some aspects, the values 526 may be determined by a machine learning model that processes historical data to determine the values 526. For example, the IT services company may process historical billing data to determine that enabling an autoscaler in the data explorer of value 520-F has resulted in a proportionally large cost reduction. The machine learning model may be trained to output a large or smaller weight value based on this information. Other data that may be analyzed includes performance logging data. For example, an unsupervised machine learning model may be trained using historical CPU load information, and may determine that configuring manual throughput in CosmosDB at value 520-E results in more stable performance. Thus, the machine learning model may increase the weight value of the corresponding ruleset in value 520-E. Many other such machine learning-based dynamic weighting applications are envisioned.

Advantageously, by using machine learning to determine the weights, human bias can be removed from the process of assigning weights. For example, the values (i.e., weights) may be determined by the one or more machine learning models trained by the machine learning training module 134 of FIG. 1A. In some aspects, the recommendation engine 136 may operate the one or more trained machine learning models, and may output the one or more weights. Once the recommendation engine 136 (or another module) uses a trained machine learning model to generate the weights, the recommendation engine 136 may store the weights in association with the keys 524, within the lists of rules 516, within the rule categories 514.

The dictionary data structure 512 is hierarchical, enabling the rules to be clustered by category (e.g., by cloud computing vendor, type, cloud computing value proposition (e.g., cost savings vs. operational excellence as in the depicted example, etc.). Additional levels of nesting may be added to further categorize/group rules. The hierarchical structure of the dictionary data structure 512 also enables the rules to be filtered (i.e., searched) and sorted/ranked (e.g., by weight).

### Example Cloud Access, Integration and Provisioning Graphical User Interfaces

For customers not buying cloud services via the IT solutions provider, it may be necessary for the user to grant permissions to the IT solutions provider to access their various cloud instances, so that the present techniques (e.g., the cloud maturity system 104) can access the statistics and analytics of the user's cloud(s). For customers buying cloud services via the IT solutions provider, the IT solutions provider may already have the data that is needed and may not need to download it.

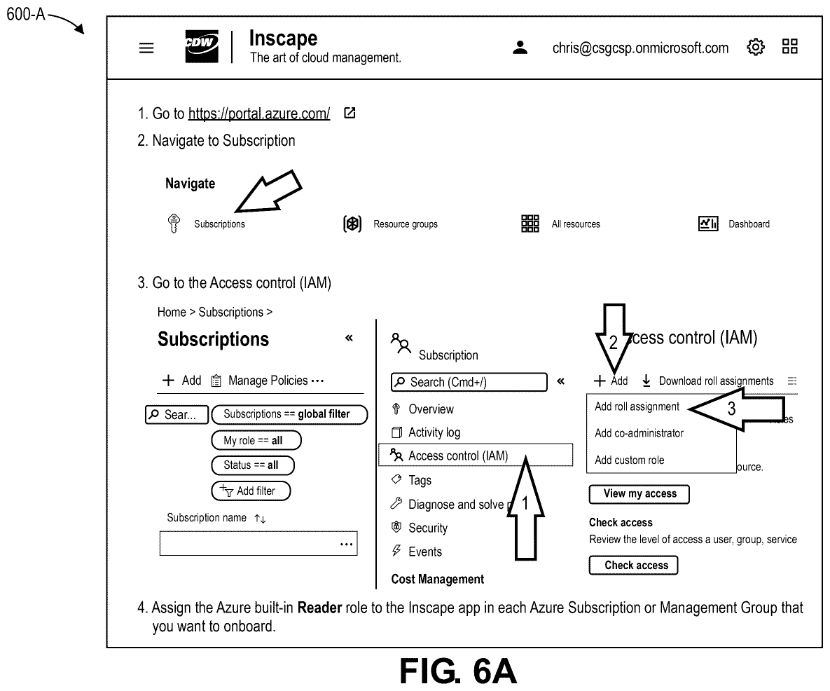

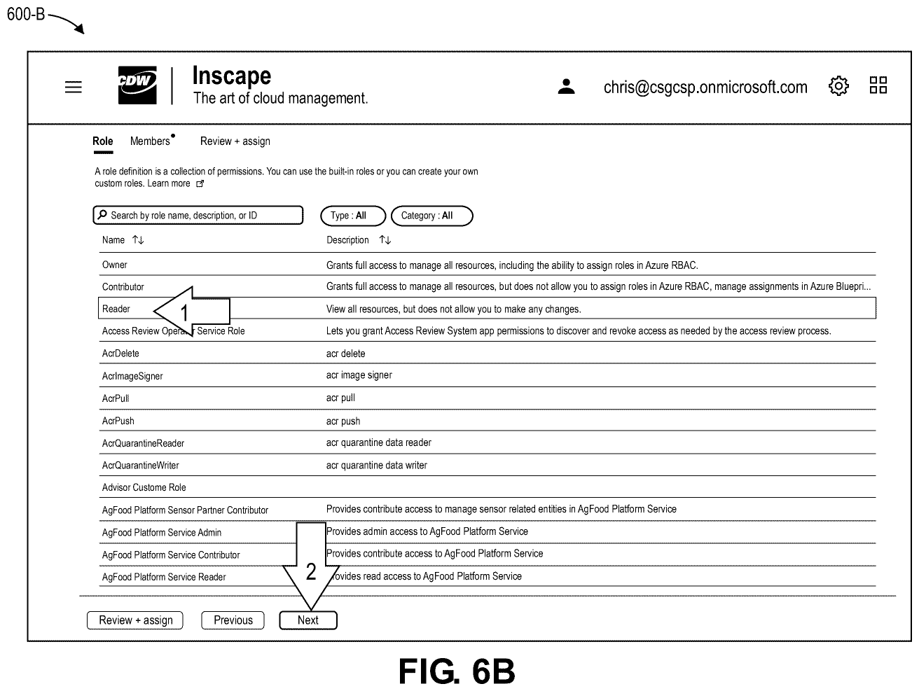

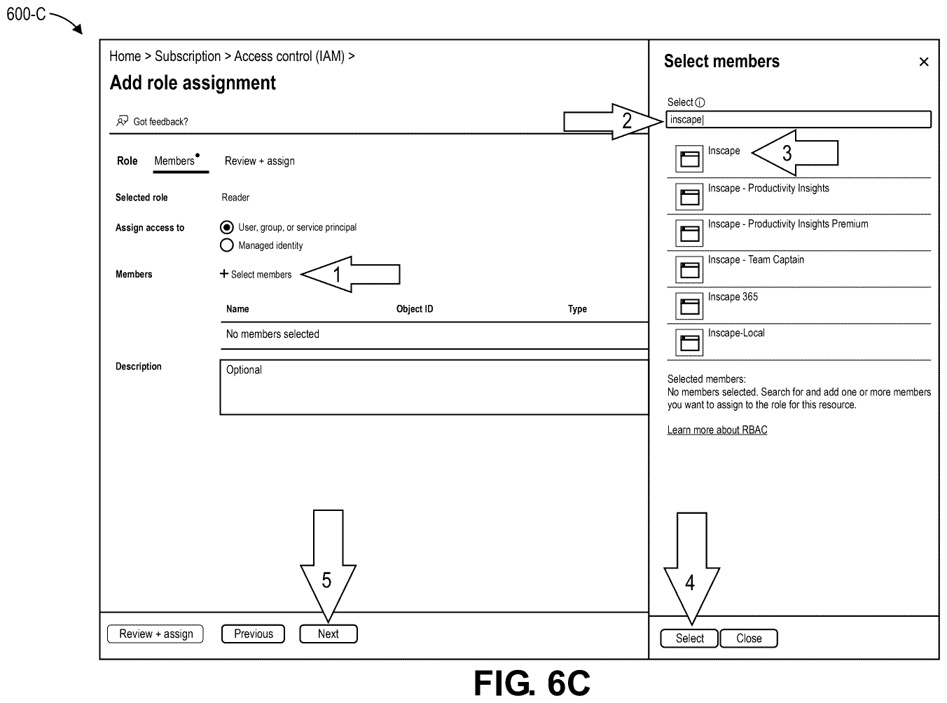

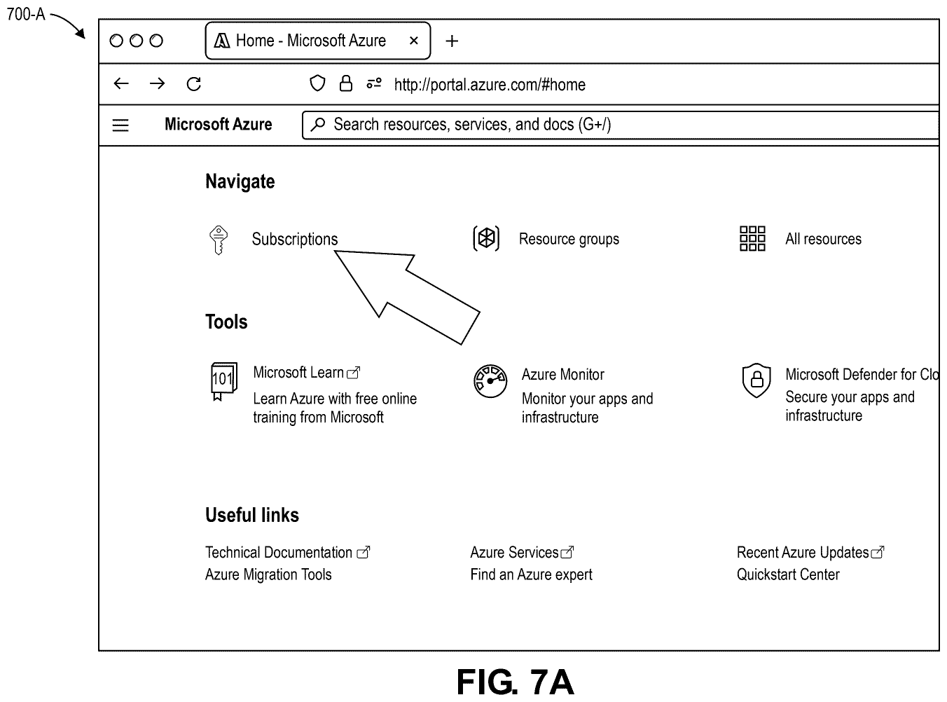

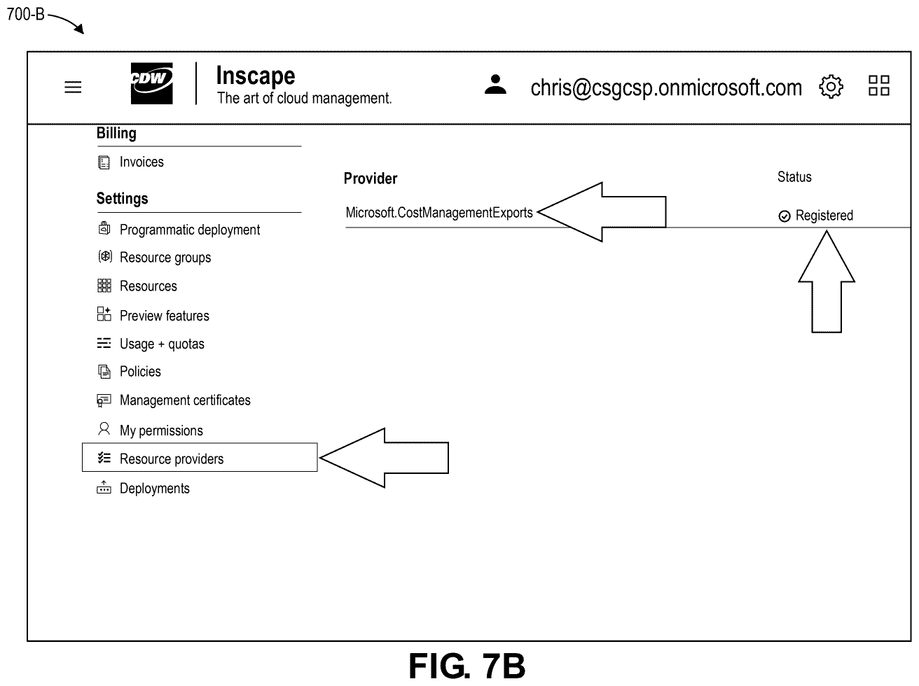

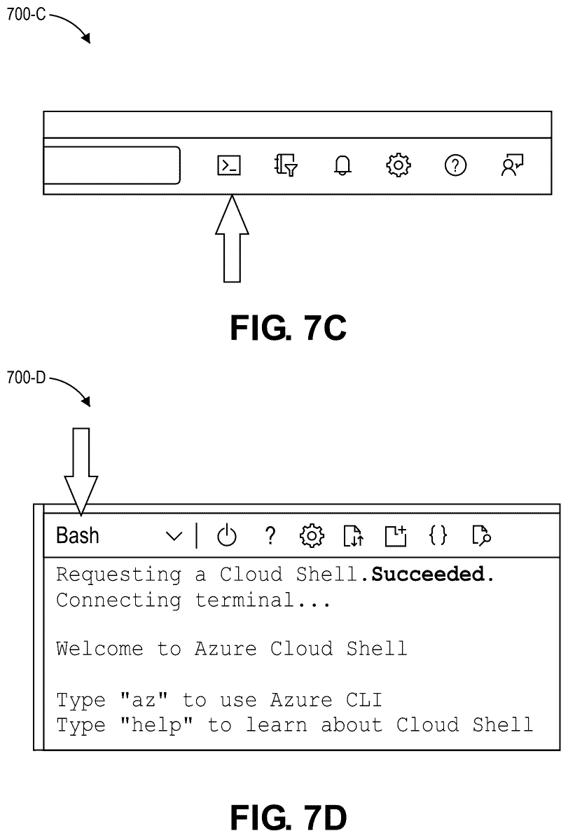

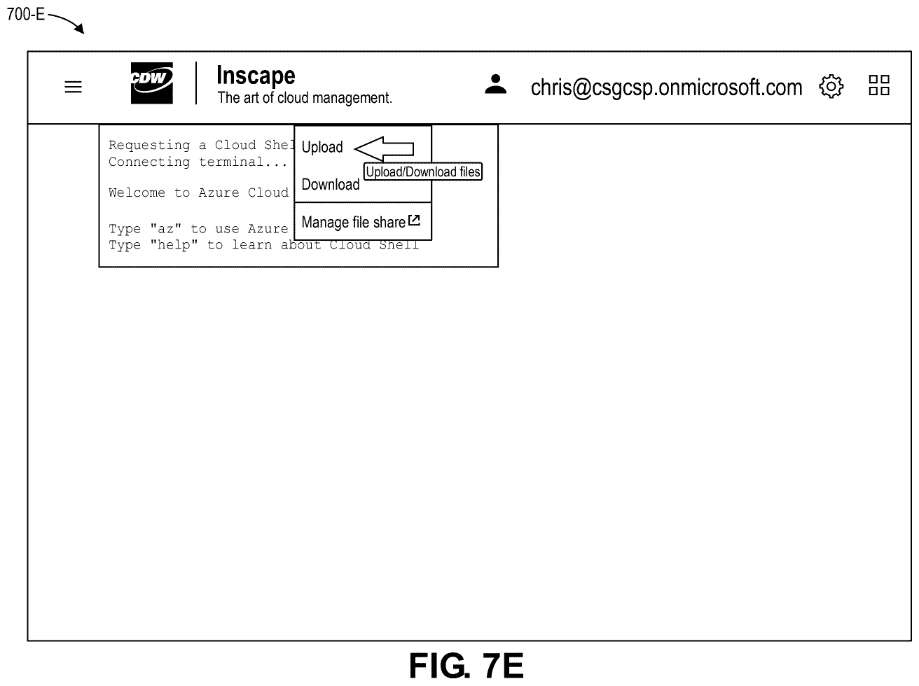

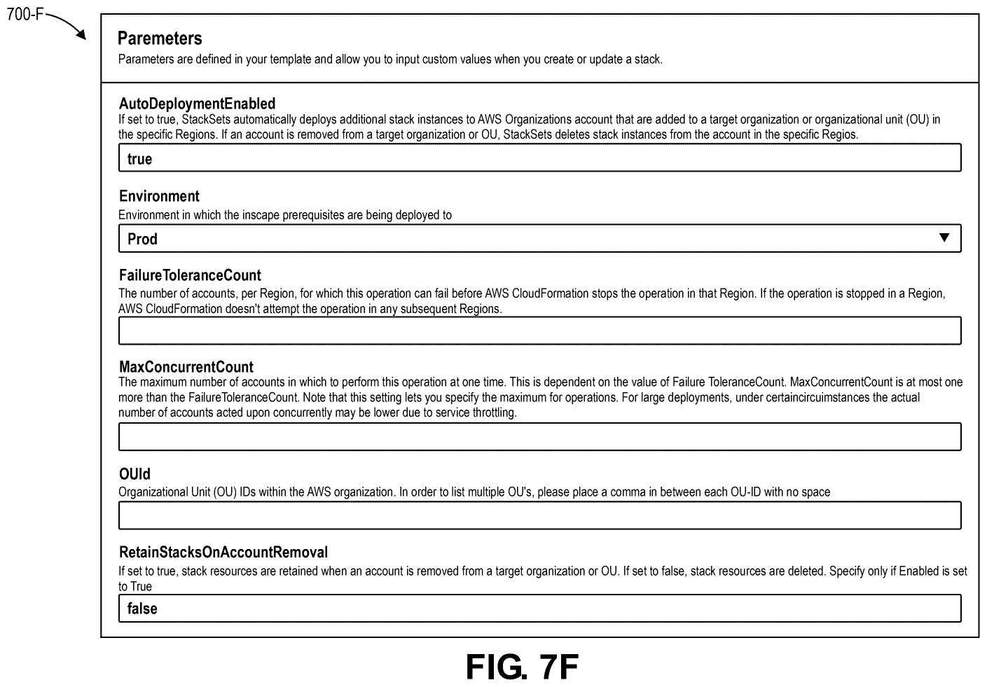

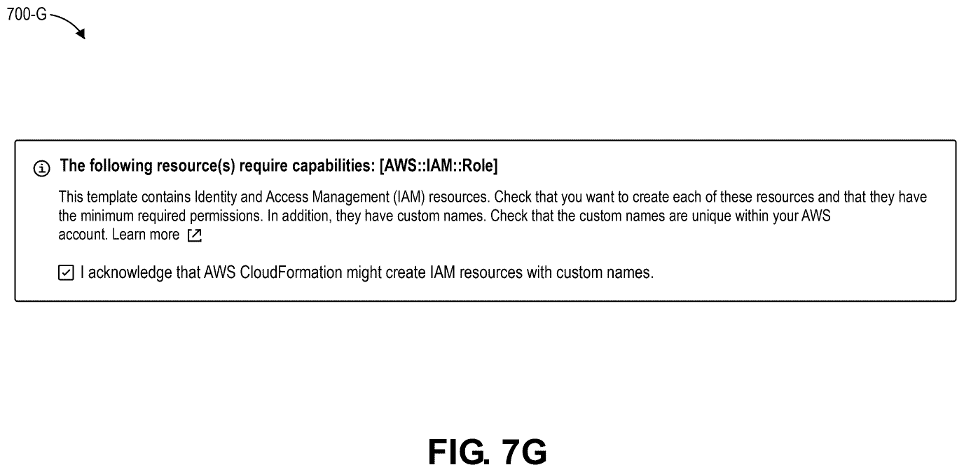

For example, FIG. 6A depicts graphical user interfaces for accessing cloud computing access control resources, according to some aspects. FIG. 6B depicts graphical user interfaces for accessing cloud computing access control resources, according to some aspects. FIG. 6C depicts graphical user interfaces for accessing cloud computing access control resources, according to some aspects. FIG. 7A depicts graphical user interfaces for accessing cloud computing subscription resources, according to some aspects. FIG. 7B depicts graphical user interfaces for accessing cloud computing cost management exports, according to some aspects. FIG. 7C depicts graphical user interfaces for accessing cloud shells, according to some aspects. FIG. 7D depicts graphical user interfaces for accessing a cloud shell terminal, according to some aspects. FIG. 7E depicts graphical user interfaces for uploading/downloading files (e.g., scripts) to the cloud shell terminal, according to some aspects. FIG. 7F depicts graphical user interfaces for accessing and deploying Identity Access Management (IAM) resources, according to some aspects. FIG. 7G depicts graphical user interfaces for confirming access to IAM resources, according to some aspects.

In some aspects, some or all of the data entry steps via the user interfaces of FIGS. 6A-7G may be automated via scripting.

### Exemplary Computer-Implemented Methods

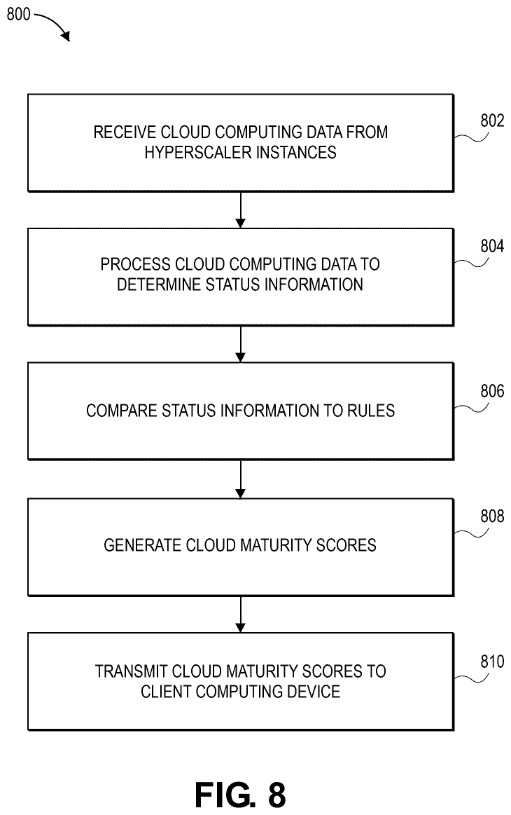

FIG. 8 depicts an example computer-implemented method 600 for providing cloud maturity scores to improve cloud computing health, according to some aspects. For example, the method 800 may be implemented using the cloud environment 100 of FIG. 1A and/or the environment 160 of FIG. 1B.

The method 800 may include receiving, via one or more processors, cloud computing data from one or more hyperscaler instances (block 802). The hyperscaler instances may include one or more of one of (i) a Microsoft Azure instance, (ii) an Amazon Web Services instance, or (iii) a Google Cloud Platform instance. As discussed, the cloud computing data may include statistical data and metrics from the one or more cloud computing platforms. In some aspects, the method 800 may include normalizing the data received from multiple cloud providers, so that the data can be directly compared and communicated to users (e.g., cloud administrators/technicians).

This represents a significant improvement over conventional use of cloud systems, wherein the user must access multiple portals that do not display information in a concise and centralized manner. For example, the received cloud computing data may include respective utilization information corresponding to a plurality of MariaDB instances across a plurality of cloud providers. The instructions may include normalizing the MariaDB utilization information so that each respective utilization value is comparable (e.g., expressed in the same unit, such as a percentage or an array/dictionary of values related to multiple axes of utilization such as disk usage, memory usage, replication status, CPU usage, etc.).

The method 800 may include processing, via one or more processors, the cloud computing data from the one or more hyperscaler instances to determine respective status information corresponding to the one or more hyperscalers (block 804). Specifically, the method 800 may include evaluating propositions or statements (e.g., computer code) stored in a data structure, such as the actions 524 in the cloud computing rules 510 data structure.

The method 800 may include comparing, via one or more processors, the respective status information to one or more rules in a rules data structure (block 806). To continue the above example, the method 800 may process the MariaDB utilization information to determine whether the MariaDB instance(s) are underutilized. When the processing at this step indicates that any of the MariaDB instance(s) are underutilized, the ruleset 520-B of FIG. 5O may be triggered (i.e., evaluated to True), causing the value 526 representing a corresponding weight for rectifying the problem (i.e., right-sizing the underutilized instance) to be available for incrementing the user's cloud maturity score.

In some aspects, the method 800 may include instructions for storing the status information generated by the comparing (e.g., in the database 108 of FIG. 1A). The method 800 may include instructions that require multiple evaluations to occur before the user's cloud maturity score will be affected. For example, the method 800 may generate a moving average of the status information over an hour, a day, a week or a longer period of time. In this example, the method 800 may only decrement the user's cloud maturity score for the underutilized MariaDB instance once the underutilization evaluation for that instance is True for more than a predetermined period of time (e.g., three hours). This advantageously prevents the user's cloud maturity score from being affected by temporary utilization spikes. In still further aspects, the method 800 may include processing the stored status information to identify the presence of utilization values (e.g., maximum values) that indicate usage patterns requiring increased load balancing or other cloud management practices.

The method 800 may include generating, based on the comparing, one or more cloud maturity scores each corresponding to one of the one or more rules (block 808). Continuing the example, the method 800 may receive/retrieve a score of the user (e.g., via the electronic database 108 of FIG. 1A). The method 800 may increment or decrement the cloud maturity score of the use based on the evaluation of the one or more rules. For example, continuing the above example, the method 800 may decrement the user's cloud maturity by the value 526, until such time that the cloud computing data received from the one or more hyperscaler instances indicates that the underutilization of the MariaDB has been rectified.

As noted, multiple scores may be accorded to a single user. For example, the user may receive a separate cloud maturity score for each cloud instance of the user's cloud environment. In some aspects, the method 800 may accord cloud maturity scores to the user on a server or instance level. For example, the method 800 may generate respective cloud maturity scores for a web server, a database server, and a load balancing server. In some aspects, the method 800 may generate respective cloud maturity scores on a service-by-service level. For example, the method 800 may score the user's Apache web server, the user's NGINX web server, and the user's Microsoft web server separately. In still further examples, the method 800 may aggregate one or more scores, to enable the user to gauge performance of servers, services, or other categorical or functional groupings of software, hardware and/or services.

The method 800 may include transmitting, via an electronic network, the one or more cloud maturity scores to a client computing device (block 810). The method 800 may include generating a table of one or more recommendations based on the one or more cloud maturity scores; and causing the table to be displayed in a graphical user interface of a client computing device, For example, the score(s) may be communicated to the user via a graphical user interface such as the cloud environment maturity graphical user interface 400 depicted in FIG. 4A and FIG. 4B. As discussed, the method 800 may include displaying the cloud maturity score(s) in numerical, textual and/or pictorial/graphical form. The displayed cloud maturity scores may be shown in detail as recommendations for improvement.

Specifically, the method 800 may show some or all of the actions 524 as opportunities for improvement, when the processing of data from the one or more hyperscaler instances indicates that the status of the action is False. The recommendations include recommendations that correspond to a plurality of different cloud computing providers. This represents a solution to a problem identified in conventional cloud management practices, which is that users are required to access multiple different cloud management interfaces, all of which have different management interfaces, to attempt to correct issues in an ad hoc and disorganized fashion. By presenting a unified interface, which shows recommendations pertaining to multiple different cloud platforms (e.g., as many as 20 or more), the user no longer has to juggle multiple unwieldy interfaces, each of which as a different management interface.

The method 800 may include receiving a user selection corresponding to the table; and causing, based on the user selection, one or more actions to be performed with respect to the one or more hyperscaler instances. Specifically, the method 800 may include executing instructions that cause API calls and/or scripts to be executed using stored credentials of the user, as depicted in FIGS. 6A-7G. For example, continuing the above example, the method 800 may cause the underutilized MariaDB to be reduced in size, to right-size the utilization of that resource. This may include reducing the processing resources and/or memory resources of the instance. In some aspects, this may include performing a downgrade by switching the user's instance to a different predetermined service tier within the third party cloud platform.

In some aspects, the method 800 may determining and/or updating one or more weights of the rules data structure. For example, the machine learning training module 134 of FIG. 1A may process historical data using a trained machine learning model. The historical data may include cloud computing data collected from one or more hyperscaler instances via the hyperscaler module 130. The historical data may be stored in the database 108, for example. The historical data may include status information generated by processing the cloud computing data (e.g., statistics and metrics). In some aspects, the historical data may include data normalized as discussed herein. In some aspects, the machine learning training module 134 may process the data to identify anomalies. For example, the machine learning training module 134 may apply an unsupervised learning algorithm that clusters events corresponding to downtime, server crashes, spikes in CPU utilization, data storage issues, etc. For example, the unsupervised machine learning algorithm may determine that a certain log file is several gigabytes in size. The machine learning training module 134 may train a model to output recommendations regarding the toggling of configuration parameters to avoid the creation of such large log files. In some aspects, the machine learning training module 134 may train a supervised machine learning model using labeled training data. The labeled training data may include a set of log messages related to security vulnerabilities or outdated software. The machine learning training module 134 may train the supervised model to identify de novo messages related to such issues within the user's cloud environment, and to generate recommendations (actions) and cloud maturity weights for fixing such issues.

The method 800 may include processing determining an industry that the one or more hyperscalers are operating within by analyzing the cloud computing data from the one or more hyperscaler instances; and adjusting one or more of the weights of the rules data structure based upon the industry. For example, a multiplier may be added to any weight of any action corresponding to personally-identifiable information in the healthcare sector. For other industries (e.g., financial customers) other weights may be emphasized (e.g., instance performance/network latency/fault tolerance). For still other customers/users, cost reduction may be a paramount concern, and may be used to set weights. For example, a machine learning model may be trained that seeks to identify and eliminate any excess capacity. The method 800 may infer the industry of the user based on the activities of the user's cloud instances. In some aspects, the method 800 may include receiving answers to a questionnaire in which the user self-identifies the user's industry. As discussed above, in some aspects, the behavior of the customer/user may be analyzed to determine how to adjust weights. For example, a company may consistently delegate 50% utilization across cloud providers. The present techniques may infer this behavior (e.g., using a trained behavior analysis machine learning model) and increase the customer's cloud maturity score when that inferred metric is reached.

The method 800 may include ranking the user against other like industry customers/peers. The ranking may indicate the user's overall ranking against other users and their respective cloud instances (which may number in the hundreds or thousands). The method 800 may provide recommendations based on a customer/user profile, which are tailored for the specific customer. The method 800 may provide a ranking among a given industry. For example, the cloud maturity score of FIG. 4A may be shown as among a given cohort of users (e.g., among health care providers), depicting the user's performance within that cohort (e.g., “your cloud maturity score ranks fourth among health care providers.”)

### Exemplary Computer-Generated Digital Reports

As discussed herein, the present techniques may include computer-executable instructions for generating one or more digital reports. For example, the cloud maturity system 104 of FIG. 1A may include a report generating module (not depicted) that generates one or more reports based on information collected from the cloud environment ENV1. For example, the hyperscaler collection module 130 may collect information corresponding to one or more of the cloud instances of a particular user or customer, and the report generation module may retrieve that information, which may have been processed further, from the database 108. The report generation module may construct one or more reports by interpolating the information retrieved from the database 108 into one or more pre-determined report templates, which may be stored in the memory 112 of the cloud maturity system 104, for example.

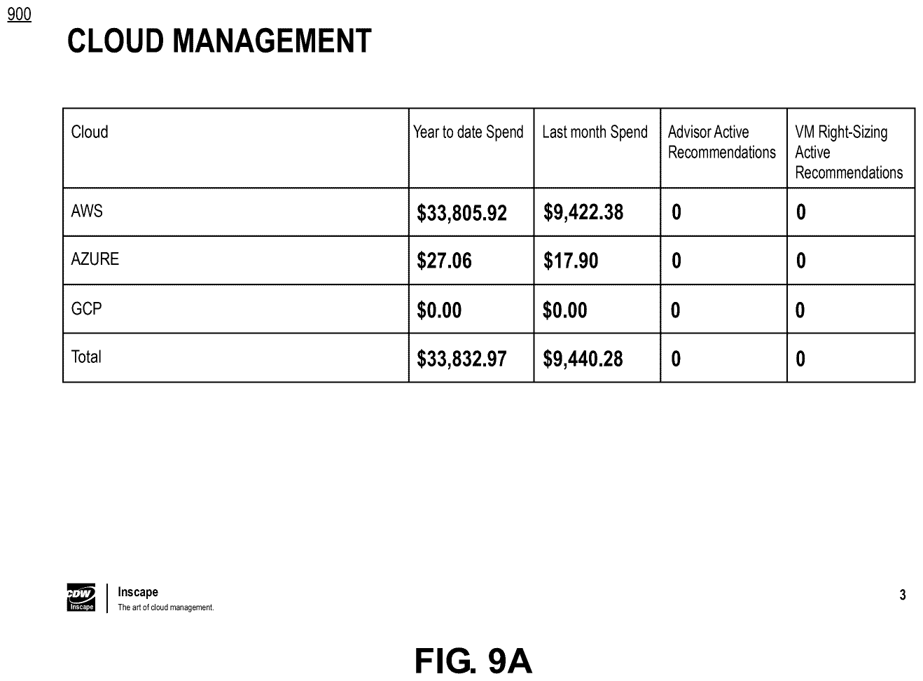

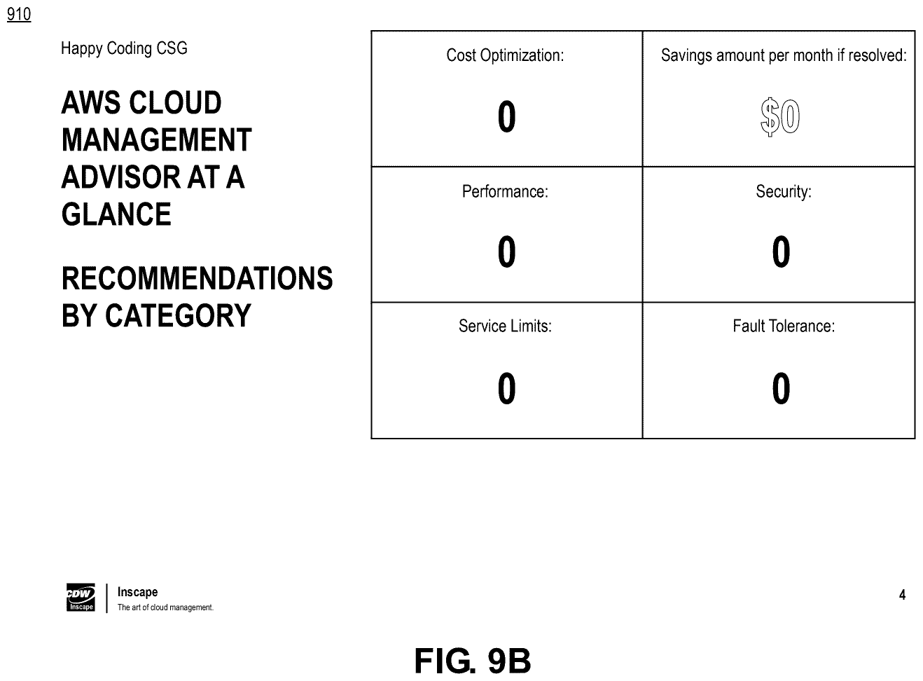

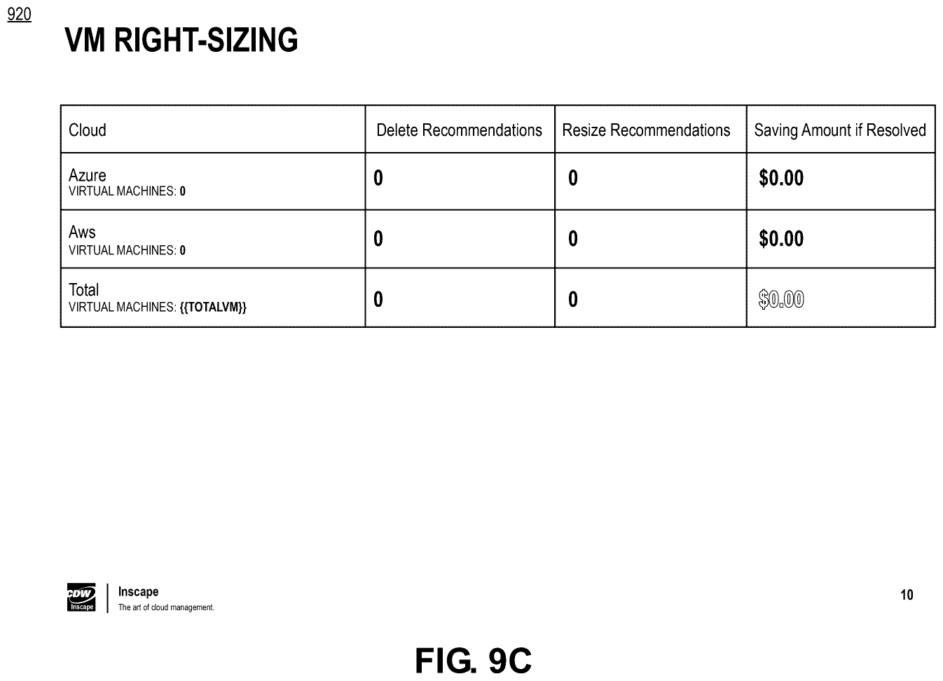

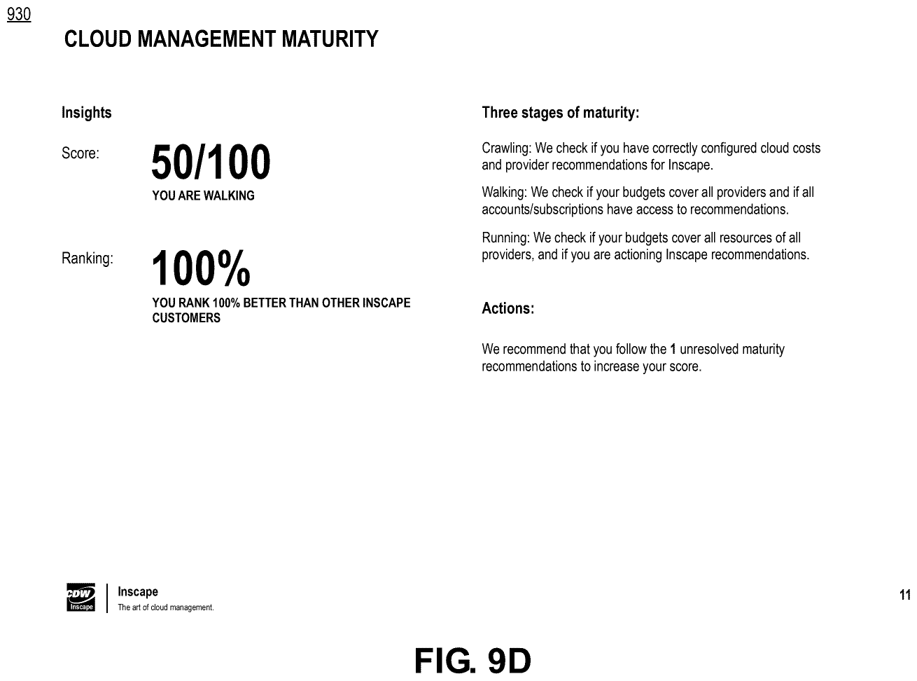

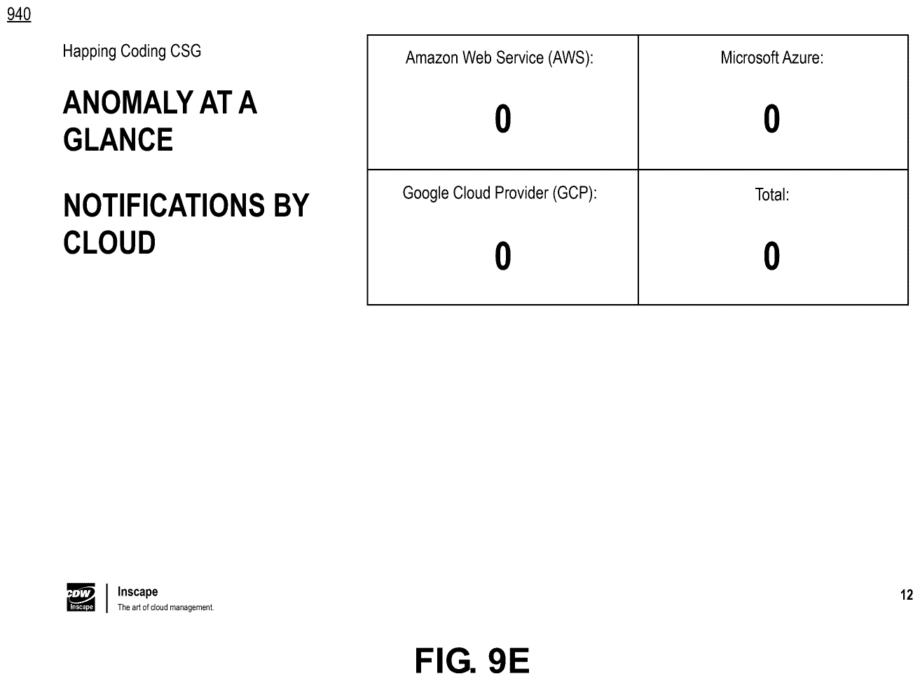

For example, FIG. 9A depicts an exemplary graphical user interface for displaying a multicloud management spending statistics and recommendations report 900, according to some aspects. FIG. 9B depicts an exemplary graphical user interface for displaying a multicloud management potential spending savings/recommendations by category report 910, according to some aspects. FIG. 9C depicts an exemplary graphical user interface for displaying a multicloud management spending statistics/virtual machine (VM) rightsizing recommendation report 920, according to some aspects. FIG. 9D depicts an exemplary graphical user interface for displaying a multicloud management maturity score report 930, according to some aspects. FIG. 9E depicts an exemplary graphical user interface for displaying a multicloud management anomaly report 940, according to some aspects. It should be appreciated that the reports in FIGS. 9A-9E are for expository purposes only, and that additional reports, with production quality interpolated, are envisaged.

### Additional Considerations

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, which is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one aspect” or “an aspect” means that a particular element, feature, structure, or characteristic described in connection with the aspect is included in at least one aspect. The appearances of the phrase “in one aspect” in various places in the specification are not necessarily all referring to the same aspect.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the aspects herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular aspects and applications have been illustrated and described, it is to be understood that the disclosed aspects are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A computer-implemented method for optimizing cloud computing configurations based on cloud maturity scores, comprising:
receiving generated cloud maturity scores related to one or more hyperscaler instances;
identifying, based on the one or more cloud maturity scores, one or more optimization recommendations for adjusting cloud configurations of one or more hyperscaler instances;
implementing the one or more optimization recommendations to adjust the cloud configurations; and
generating one or more updated cloud maturity scores.

2. The method of claim 1, wherein the optimization recommendations are directed to reducing costs associated with the cloud computing configuration.

3. The method of claim 1, wherein the optimization recommendations are based on a customer profile.

4. The method of claim 1, further comprising receiving user-selected recommendations and automatically implementing adjustments to the one or both of the hyperscaler instances and cloud configurations.

5. The method of claim 1, wherein the optimization recommendations are industry-specific optimization recommendations.

6. The method of claim 5, wherein the industry-specific optimization recommendations are determined using a trained machine learning model trained with industry-specific criteria.

7. The method of claim 5, wherein industry-specific criteria for optimization comprise at least one of compliance requirements, performance benchmarks, and cost efficiency metrics specific to an industry segment.

8. The method of claim 1, further comprising dynamically updating recommendations based on feedback related to the implemented optimization recommendations applied to one or both of the hyperscaler instances and cloud configurations.

9. The method of claim 5, further comprising generating visual representations of predicted outcomes of the industry-specific optimization recommendations using pre-trained machine learning models.

10. The method of claim 1, further comprising displaying the optimization recommendations via a graphical user interface on a client computing device.

11. A computing system for optimizing cloud computing configurations, comprising:
one or more processors; and
one or more memories having stored thereon computer-executable instructions that, when executed by the one or more processors, cause the computing system to:
receive generated cloud maturity scores related to one or more hyperscaler instances;
identify, based on the one or more cloud maturity scores, one or more optimization recommendations for adjusting cloud configurations of one or more hyperscaler instances;
implement the one or more optimization recommendations to adjust the cloud configurations; and
generate one or more updated cloud maturity scores.

12. The computing system of claim 11, wherein the optimization recommendations are directed to reducing costs associated with the cloud computing configuration.

13. The computing system of claim 11, wherein the optimization recommendations are based on a customer profile.

14. The computing system of claim 11, the one or more memories having stored thereon computer-executable instructions that, when executed by the one or more processors, further cause the computing system to:
receive user-selected recommendations and automatically implement adjustments to one or both of the hyperscaler instances and cloud configurations.

15. The computing system of claim 11, wherein the optimization recommendations are industry-specific optimization recommendations.

16. The computing system of claim 15, wherein the industry-specific optimization recommendations are determined using a trained machine learning model trained with industry-specific criteria.

17. The computing system of claim 15, wherein industry-specific criteria for optimization comprise at least one of compliance requirements, performance benchmarks, and cost efficiency metrics specific to an industry segment.

18. The computing system of claim 11, the one or more memories having stored thereon computer-executable instructions that, when executed by the one or more processors, further cause the computing system to:
dynamically update recommendations based on feedback related to the implemented optimization recommendations applied to one or both of the hyperscaler instances and cloud configurations.

19. The computing system of claim 15, the one or more memories having stored thereon computer-executable instructions that, when executed by the one or more processors, further cause the computing system to:
generate visual representations of predicted outcomes of the industry-specific optimization recommendations using pre-trained machine learning models.

20. The computing system of claim 11, wherein the one or more hyperscaler instances include one or more of one of (i) a Microsoft Azure instance, (ii) an Amazon Web Services instance, or (iii) a Google Cloud Platform instance.
